(19) United States
(12) Patent Application Publication
(10) Pub. No.: US 2002/0120714 A1
(43) Pub. Date: Aug. 29, 2002

(54) Distributed-code, custom-generated dynamic internet inclusion agent

(76) Inventor: Borislav Agapiev, Portland, OR (US)

Correspondence Address: STOEL RIVES LLP, 900 SW FIFTH AVENUE, SUITE 2600, PORTLAND, OR, 97204, US

(21) Appl. No.: 09/794,817

(22) Filed: Feb. 26, 2001

(51) Int. Cl. G06F 15/16

(52) U.S. Cl. 709/218; 709/203

(57) ABSTRACT

Preferred embodiments of the present invention comprise a system and method for enabling a novice computer user automatically to generate a customized search agent for conducting a content search on one or more remote network Web sites and aggregating the search results. The user has the ability to specify the Web sites that will be searched. The customized search agent then functions to aggregate content found on each of the sites the computer user specifies for the search. In a preferred embodiment of the present invention, the novice user employs a remote inclusion agent automatically to generate the search agent simply by using a standard network browser to interface the inclusion agent and surf Web sites that provide the desired content.

### TECHNICAL FIELD

The present invention relates to the field of distributively generating dynamic Internet search agents for locating content on the Internet and presenting the located content in a convenient, easy-to-use, aggregate format.

### BACKGROUND OF THE INVENTION

Due to the implementation of between tens to hundreds of millions of Web sites on the World Wide Web, comprising literally billions of Web pages, finding a particular item on the Internet often presents significant challenges. Often, potential consumers are not aware of the sites making information available. Even if a relevant site is located, it may not provide easy access to the content sought. The wide variety of available Web pages available on an equally wide variety of Web sites only complicates matters.

Many Web sites only advertise content that is available through physical sources, such as a brick-and-mortar establishment. Several Web sites additionally enable a retail presence on the Web, allowing consumers to procure an item directly online in a business-to-consumer (“B2C”) transaction. Business-to-business (“B2B”) exchanges have also been created to allow businesses to manage inventor directly online. One business can buy items from (or sell items to) one or more other businesses using a Web site. For those sites that do provide an online retail or B2B presence, each site often uses a different search methodology or user interface, causing potential confusion for participating customers or businesses. The term “search methodology” refers to the protocol of steps required to search for content on a Web site. That content is usually stored on or accessed through a remote server computer that hosts the Web site.

Fundamentally, for a Web site to be useful, a user must be able to locate it. However, even after the Web site is located, the customer still must learn how to isolate or search for desired content on that Web site. Due to the large number of pages and the fact that the search methodologies of pages vary widely, finding content can be difficult and very time consuming. While a consumer could save time by only searching Web sites with which he is already familiar, the consumer does not necessarily know the best sites providing the desired content. Accordingly, the consumer runs the risk of the desired content being available under more favorable terms on an alternate site. Without searching the content of multiple pages, the shopper cannot conduct comparisons of price or other factors quantifying or qualifying the content. On the other hand, if a consumer is aware of multiple relevant sites, the consumer must expend significant time and energy to manually search each site. Even then, it remains difficult to compare the information across sites.

Various search engines are commercially available in order to help search the vast content available on the Internet. However, these engines often provide results that are either unhelpful or too numerous to be examined in a reasonable time frame. For example, when a computer user searches for a product with a typical search engine, the user provides keywords characterizing the name or type of product, and the search engine provides URLs (typically displayed as “hyperlinks” or “links”) to Web pages on which those words are located. For common words, it is typical to obtain search results with tens of thousands of URL links. To follow each link manually would be unduly time consuming. Additionally, many of the listed sites are either not helpful or only tangentially related to the desired topic.

A few Web sites use “spiders” to gather substantive content from other Web pages and present the content to a shopper in an aggregated format. The term “spiders” refers to a general class of programs designed for automated searching of the Internet. Spiders locate Web pages and index their address and content information in a database. Typically, search engines or Web sites using spiders to compile information can only access information that is made available directly on Web pages; they cannot submit requests to Web pages using HTML forms in order to query a database. Another type of Web site, such as “MySimon.com,” allows aggregation of certain information (such as pricing information) found by searching various third-party sites. However, these types of Web sites have significant limitations. For example, they do not distribute to the user the ability to specify or limit which Web sites are included in the content search. If, for example, an individual wanted to customize a search engine to create a customized B2B exchange with preselected participant Web sites, the individual would have to develop the search engine himself in a computer programming language. However, most individuals do not have the knowledge or ability to program a customized search engine. These existing sites afford users access to the functionality of prior-written searching code stored on a remote server, but they do not distribute to users the ability to generate the remotely hosted searching code themselves.

What is needed is to enable a computer novice with minimal programming skills to program a robust, sophisticated, and customized search engine, referred to as a “search agent,” in a distributed manner, remote from the server that will host it. Generation and hosting of the search agent should be Web-based, without requiring the novice user to download or install a software development kit on his computer system. There is currently no distributed tool available for enabling automated generation of a customized search agent using hosting services and substantive programming ability made available on a remote server and accessible with a standard Internet Web browser. The present invention provides such a tool.

### SUMMARY OF THE INVENTION

The present invention allows a novice computer user to employ an inclusion agent for automated generation of a customized search agent for selectively including content stored on remote Internet Web sites in an aggregate search result. The user can specify the Web sites that will be searched, thus allowing specific functionality, such as establishing an online B2B exchange with particular participating sites. The customized search agent functions as a “dynamic aggregator,” aggregating content found on each of the sites the computer user specifies for the search. Additionally, the user can input a list of sites to be searched from a separate source, such as by importing the URLs provided in a conventional search engine result. In a preferred embodiment of the present invention, the novice user employs the inclusion agent while ostensibly only using a standard network browser to surf Web sites that provide the desired content. The inclusion agent auto-generates code defining a customized search agent used for subsequent searches. The user need not obtain any special software developers' packages. Such a system is valuable because, while it distributes part of the task of generating code to users, the actual code generation is substantially automated, thus making it simple enough for novices to use.

In a preferred method according to the present invention, an “inclusion server” is coupled to the Internet. The inclusion server hosts a series of computer programs or routines used to identify and emulate the search methodology of a selected site. The search methodology is then included by the inclusion agent when generating a customized search agent. This process is referred to as “learning” the search methodology of a Web site. A first communication session is established between the remote-user's client system and the inclusion server. A second communication session is then established between the inclusion server and one or more content servers hosting Web sites, the search methodologies of which are to be learned by the inclusion agent.

Communications between the client and the content servers are routed through the inclusion server. The appearance of the Web pages served by the content server remains substantially unaltered, but the inclusion server's inclusion agent monitors and analyzes the communications in order to determine and record the search methodology used to access content on each content server. The inclusion agent can then implement the learned search methodology when generating a customized search agent. While it seems to the user that he is only surfing the Web sites on the content servers, the user is actually employing the inclusion agent to generate code for a customized search agent that will conduct subsequent, automated searches for the user. After the customized search agent is created, the user only has to interface with it in order to search any or all of the sites for which the inclusion agent has included a search methodology (i.e., each site that the inclusion agent has “learned”). Once the inclusion agent has learned the search methodology for a site by searching for one item, it generates the customized search agent with variables replacing values for the item being searched in order to enable the methodology to search for any other item on that site as well.

The inclusion server preferably hosts a series of computer programs or routines that cumulatively provide code-generating functionality. Several of these programs can provide a series of user-friendly interfaces to a remote client. These can primarily comprise interactive Web pages viewable with a standard network browser. Examples include a start Web page for receiving the URL for the Web sites to be included by the inclusion agent, a search Web page for providing a uniform interface for accessing the search agent and receiving subsequent search requests, and a results Web page for aggregating results from a search conducted on the included sites.

The inclusion server also can include a series of programs or routines that are substantially hidden from the remote user. In a preferred embodiment, scripts are used to pass data between the inclusion server and the interfaces provided to the remote user. The scripts can include an inclusion script for recording the search methodology implemented on each Web site being learned, a search script for searching the learned sites responsive to a user's search request, and a results script for aggregating the search results from several Web sites into a consolidated output.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 is a schematic representation of client-server communication session of the prior art.

FIG. 2 is a schematic representation of a client-server communication with the additional intervention of an inclusion server consistent with the present invention.

FIG. 3 depicts a B2C search request communications flow typical of the prior art.

FIG. 4 depicts a B2C search request communications flow consistent with a preferred embodiment of the present invention.

FIG. 5 depicts a B2B exchange search request communications flow consistent with a preferred embodiment of the present invention.

FIG. 6 presents a flowchart illustrating steps of a code-generation phase of a preferred embodiment of the present invention.

FIG. 7 presents a flowchart illustrating steps of a search phase of a preferred embodiment of the present invention.

FIG. 8 diagrams a preferred embodiment of programs comprising an inclusion server, including user-friendly interfaces made available to a novice computer user, and code-generating programs substantially hidden from the novice user.

FIG. 9 presents a flowchart of steps implementing the functionality of a Start Web Page consistent with a preferred embodiment of the present invention.

FIG. 10 presents a flowchart of steps implementing the functionality of an Inclusion Script First Routine consistent with a preferred embodiment of the present invention.

FIG. 11 presents a flowchart of steps implementing the functionality of an Inclusion Script Second Routine consistent with a preferred embodiment of the present invention.

FIG. 12 presents a flowchart of steps implementing the functionality of a Search Web Page consistent with a preferred embodiment of the present invention.

FIG. 13 presents a flowchart of steps implementing the functionality of a Code Script consistent with a preferred embodiment of the present invention.

FIG. 14 presents a flowchart of steps implementing the functionality of a Results Script consistent with a preferred embodiment of the present invention.

FIG. 15 presents a flowchart of steps implementing the functionality of a Results Web Page consistent with a preferred embodiment of the present invention.

FIG. 16 illustrates an example of the Start Web Page of FIG. 9 and an example of the Search Web Page of FIG. 12.

FIG. 17 illustrates the Start Web Page of FIG. 16 with initial values supplied in the search parameter fields for learning and including the search methodology of a first Web site by the inclusion agent.

FIG. 18 illustrates a first response Web page from the first Web site. The first response Web page is depicted containing HTML form elements.

FIG. 19 illustrates a second response Web page from the first Web site. The second response Web page also is depicted containing HTML form elements.

FIG. 20 illustrates a results Web page from the first Web site. The results Web page depicts a lack of HTML form elements and presents the results in a HTML table entry.

FIG. 21 illustrates the Search Web Page of FIG. 16 depicting the inclusion of the first learned Web site in the site-selection option field.

FIG. 22 illustrates the Start Web Page of FIG. 16 with initial values supplied in the search parameter fields for learning and including the search methodology of a second Web site by the inclusion agent.

FIG. 23 illustrates a first response Web page from the second Web site. The first response Web page is depicted containing HTML form elements.

FIG. 24 illustrates a results Web page from the second Web site. The results Web page depicts a lack of HTML form elements and presents the results in a HTML table entry.

FIG. 25 illustrates the Search Web Page of FIG. 16 depicting the inclusion of the second learned Web site in the site-selection option field.

FIG. 26 illustrates the Start Web Page of FIG. 16 with new initial values supplied in the search parameter fields for learning and including the search methodology of a third Web site in the inclusion agent.

FIG. 27 illustrates a first response Web page from the third Web site. The first response Web page is depicted containing HTML form elements.

FIG. 28 illustrates a results Web page from the third Web site. The results Web page depicts a lack of HTML form elements and presents the results in a HTML table entry.

FIG. 29 illustrates the Search Web Page of FIG. 16 depicting the inclusion of the third learned Web site in the site-selection option field.

FIG. 30 illustrates the Search Web Page of FIG. 16 depicting the inclusion of all three learned Web site in the site-selection option field. In FIG. 30, a computer user has selected to conduct a search on all of the learned and included Web sites.

FIGS. 31A-31C illustrate an example of the Results Web Page of FIG. 15 generated in response to the user search request for all learned and included sites from FIG. 30. The Results Web Page of FIGS. 31A-31C includes results from all three of the learned and included sites.

FIG. 32 illustrates the Search Web Page of FIG. 16 depicting the inclusion of all three learned Web sites in the site-selection option field. In FIG. 30, a computer user has selected to conduct a second search for new content on all of the learned and included Web sites.

FIGS. 33A and 31B illustrate an example of the Results Web Page of FIG. 15 generated in response to the second user search request for all learned and included sites from FIG. 32. The Results Web Page of FIGS. 33A and 33B includes results from two of the three learned and included sites, and depicts a situation where one site did not have content satisfying the second user search request.

### DETAILED DESCRIPTION OF A PREFERRED EMBODIMENTS

The present invention generally comprises a system and method for enabling a novice computer user to employ a Web learning inclusion agent (hereinafter “inclusion agent”) for automated generation of a customized search agent for searching the content of multiple Web pages and incorporating the content into an aggregate result. In a preferred embodiment, the inclusion agent and search agent encompass one or more computer programs, scripts, modules, procedures, or routines for collectively providing the functionality necessary to enable the searching of multiple Web pages and provide an aggregate result. Consistent with the present invention, the inclusion agent can be implemented by a novice computer user under a distributed, Web-based paradigm. The code comprising the inclusion agent and search agent can maintain a remote presence on the network, and it does not have to be stored on the local system of the client who generated the inclusion agent. Accordingly, using tools available on a remote server, a client can generate a search agent that is hosted on that or another remote server. In a preferred embodiment, the inclusion agent operates consistently with HTTP standard request paradigms in order to ensure functionality in a wide variety of network environments. The preferred embodiment of the present invention functions under the get or post methods of HTTP communications.

To facilitate novice computer users in generating code, an inclusion server is made available. The inclusion server hosts an inclusion agent used to identify a search methodology for a site and implement the identified search methodology in a dynamically-generated, customized search agent. The inclusion server routs and monitors content server requests made by a client. Thus, from a novice computer user's point of view, he only needs to establish a communications session with the inclusion server and use a standard Web browser application to “browse” the Web sites he wants to search. The code for the search agent will be generated automatically on the inclusion server. The present invention gives novice computer users the ability to custom-generate their own search agent (also referred to as a “spider” or “bot”) without possessing substantial computer programming skills.

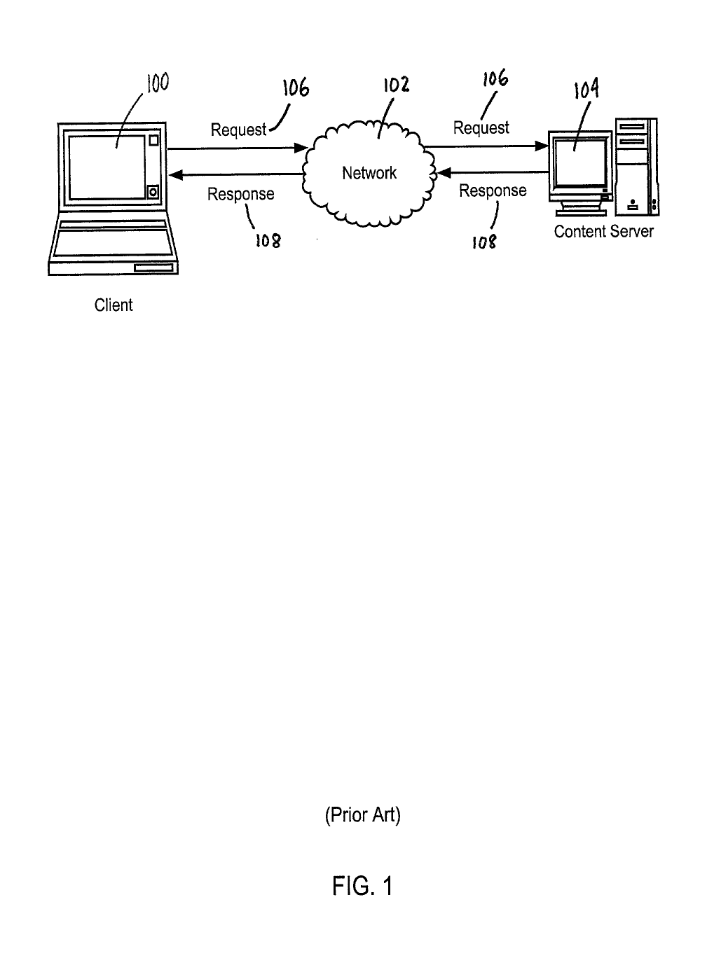

FIG. 1 illustrates a prior art system by which a client 100 searches content stored on a content server 104 where both the client 100 and the content server 104 are coupled to a network 102. In FIG. 1, the client 100 sends a request 106 through the network 102, and the request 106 is received by the content server 104. Responsive to the request 106, the content server 104 returns a response 108 through the network 102, and the response 108 is subsequently received by the client 100.

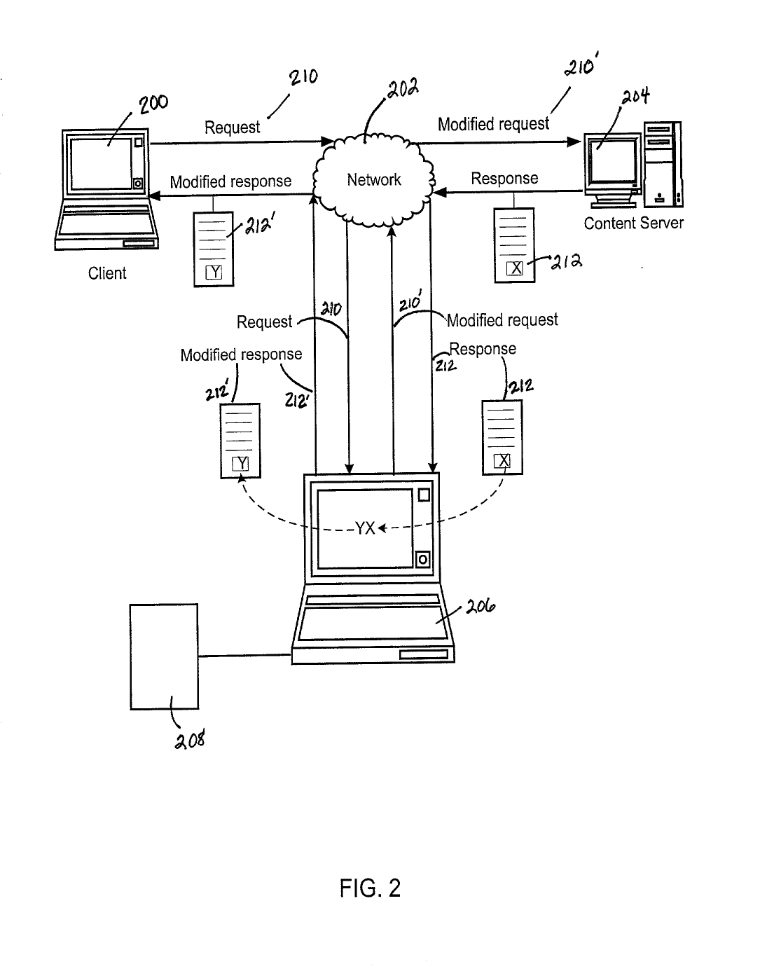

FIG. 2 illustrates a schematic of a system consistent with the present invention. In FIG. 2, a client 200 communicates with a content server 204 through a network 202. In a preferred embodiment of the present invention, the preferred network is the Internet; however, other types of networks, such as wireless, broadband, LAN, WAN, satellite, intranets, or the like, could also be employed as the network 202. However, unlike in FIG. 1, the communications between the client 200 and the content server 204 are routed through an inclusion server 206 that is also coupled to the network 202. The inclusion server 206 includes one or more computer programs 208 to monitor the communications between the client 200 and the content server 204 and record the methodology by which the client 200 searches for content made available by the content server 204.

Continuing with FIG. 2, the client 200 sends a request 210 through the network 202, and the request 210 is received by the inclusion server 206. The inclusion server 206 then sends a modified request 210′ through the network 202 to the content server 204. The request is modified so that the server will respond to the inclusion server 206, and not directly to the client 200. Responsive to receiving the modified request 210′, the content server 204 returns a response 212 through the network 202. The response 212 is received by the inclusion server 206, which then modifies the response, and the modified response 212′ is sent through the network 202 to the client 202. In the preferred embodiment, the response 212 includes data (e.g., HTML code) defining a Web page. In the modified response 212′, some information X may be removed from the data defining the Web page, and some information Y may be added to the data defining the Web page. Again, the modification (e.g., in HTML action fields) can ensure that communications will be routed through the inclusion server.

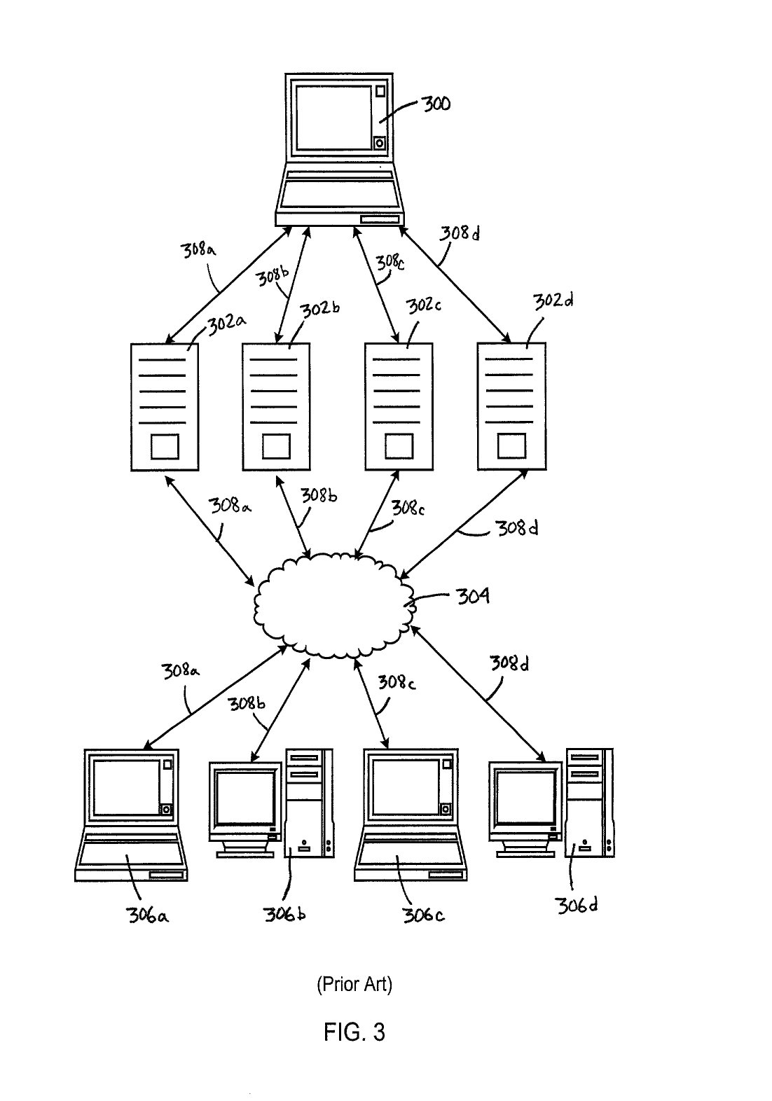

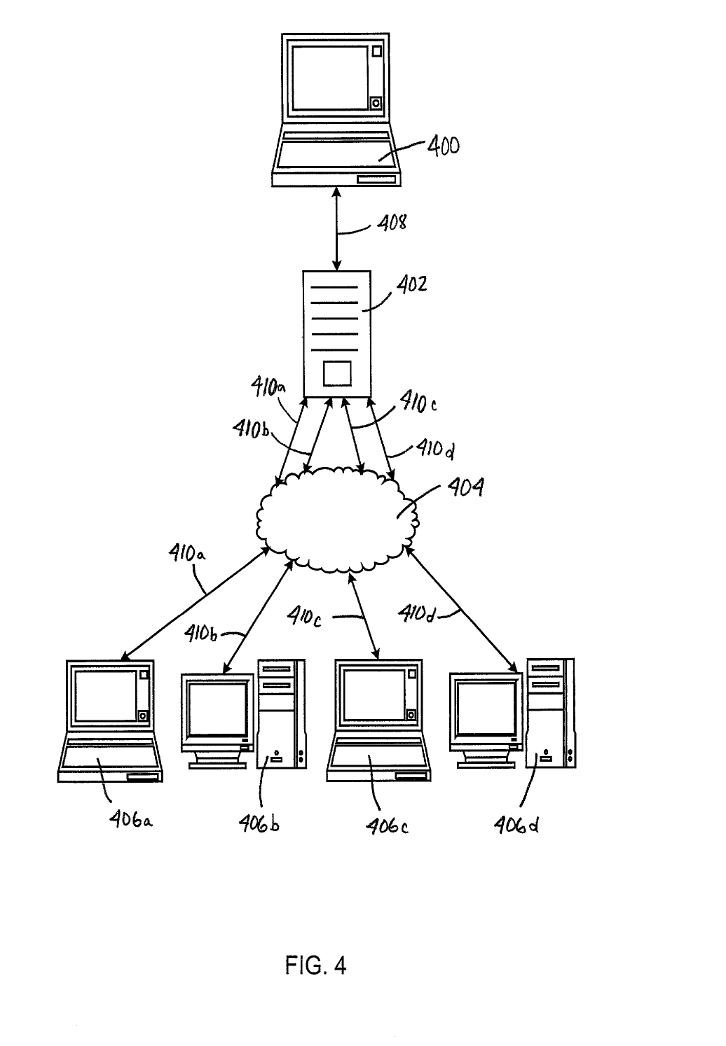

The appearance of the Web page remains substantially unaltered as it is presented to the client 200. By intercepting and rerouting communications in this manner, the inclusion server 206 is able to determine the search methodology used by the client 200 in accessing information from the content server 204. The inclusion server 206 then implements the learned search methodology in code defining a search agent for use by the client 200 in subsequent searches on the content server 204. The process illustrated in FIG. 2 can be repeated with additional content servers 204 until the client 200 has included within the search agent the search methodology for all desired sites. Once the inclusion server 206 codes the methodology to search one or more content servers 204 into the search agent, the client 200 can conduct a search of one, some, or all of the learned content servers 204 through a single search agent interface. The preferred embodiment defines a Web page as the interface to both the inclusion agent and search agent. Particular advantages of implementing embodiments of the present invention are illustrated in FIGS. 3 and 4.

FIG. 3 illustrates one example of a prior art system. In prior art systems, as illustrated in FIG. 3, if a client 300 wished to search for content on each of several content servers 306a through 306d, the client 300 would have to utilize a separate search interface 302a through 302d (which could be located on the server side as well as the client side) for each of the content servers 306a through 306d. Accordingly, the client 300 would have to establish a separate communication session 308a through 308d with each of the content servers 306a through 306d via the search interfaces 302a through 302d and the network 304. Such a process would be unduly laborious, requiring excessive time and energy.

In a preferred embodiment of the present invention, a contemporaneous search of multiple sites can be facilitated through the use of a single search interface. Such a system is illustrated in FIG. 4. With particular reference to FIG. 4, a client 400 is able to search for content made available by multiple content servers 406a through 406d via a network 404 through use of a single, consolidated search interface 402. The consolidated search interface 402 accesses a search agent (not shown) to implement the search methodology appropriate for each of the content servers 406a through 406d. The search agent is preferably hosted on a remote server (not shown). As shown in FIG. 4, the client 400 establishes a single communication session 408 through the consolidated search interface 402. The consolidated search interface 402 calls a customized search agent created by the inclusion agent to appropriately convert the single communication session 408 into individualized communication sessions 410a through 410d, each corresponding to a content server 406a through 406d. The individualized communication sessions 410a through 410d can run contemporaneously. The client 400 can send a single request and receive a single, aggregate result, regardless of the number of content servers 406a through 406d that are searched.

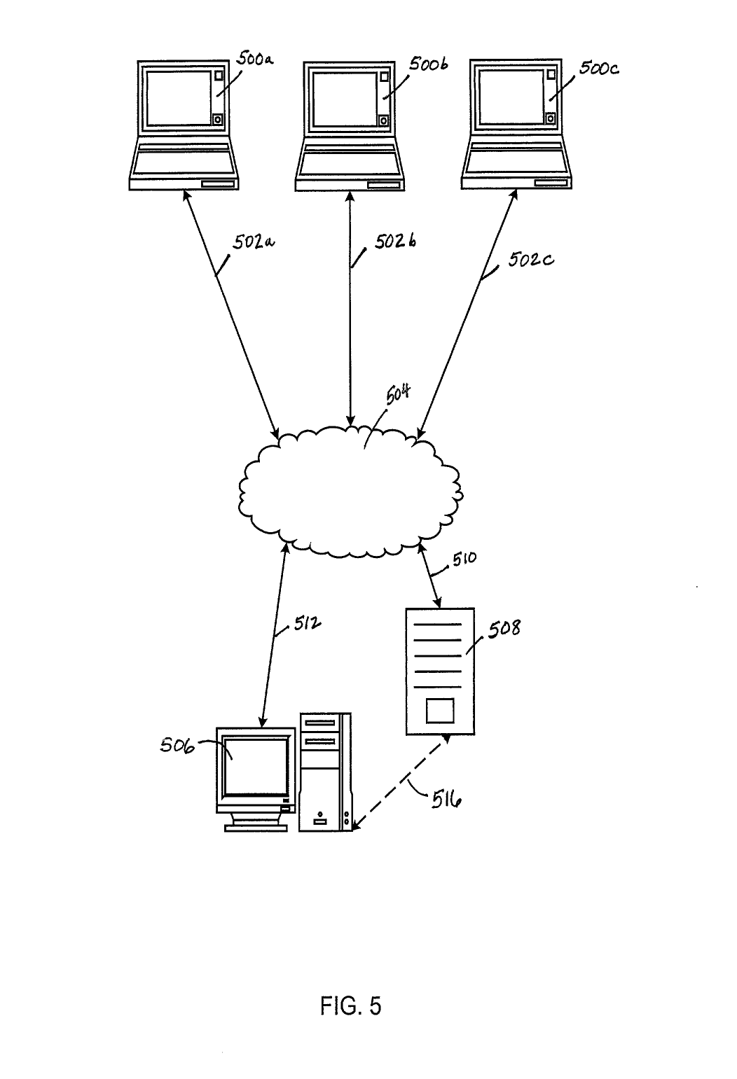

FIG. 5 illustrates an alternative implementation of the present invention in a context emulating that of a B2B exchange. With reference to FIG. 5, three entities 500a through 500c are involved in the B2B exchange. Each of the entities 500a through 500c is coupled for a presence 502a through 502c on a network 504. An inclusion server 506 is also coupled for a presence 512 on the network 504. FIG. 5 illustrates an inclusion agent 508 that maintains availability 510 via the network 504 to each of the entities 500a through 500c. In a preferred embodiment, the inclusion agent 508 is hosted 516 on the inclusion server 506. The entities 500a through 500c can establish communication sessions with the inclusion agent 508 (via the network 504). The inclusion agent 508 then can enable a first entity, say 500a, to search for content provided by each of the other entities 500b and 500c. In this manner, an embodiment of the present invention establishes an effective B2B exchange.

One example of an application would be in the context of merchants who would like to establish an exchange for inventory management with other merchants. A customer of one merchant could have his purchase request satisfied even if the merchant the customer initially contacts has to obtain the inventory from an affiliate merchant. A B2B exchange consistent with the present invention allows each of the merchants to track inventory and know what is available for sale. Similarly, by providing minimal additional communications ability known to those skilled in the art, a reverse auction system can be established. If multiple merchants have available inventory, the requesting merchant can have the other merchants auction the required item, and the lowest price is selected. Similarly, a reverse auction functionality can be provided for a B2C transaction, allowing the consumer repeatedly to determine what dynamic sales offers are available at any given time, ultimately selecting the lowest price for the desired item.

Generating a Search Agent

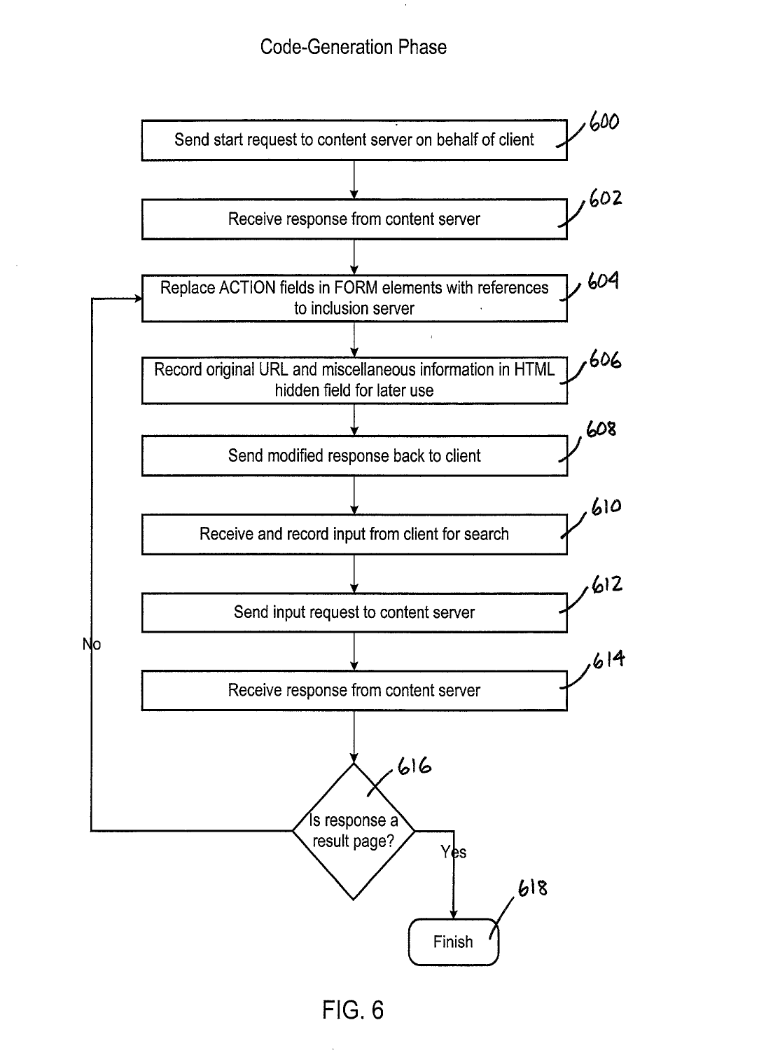

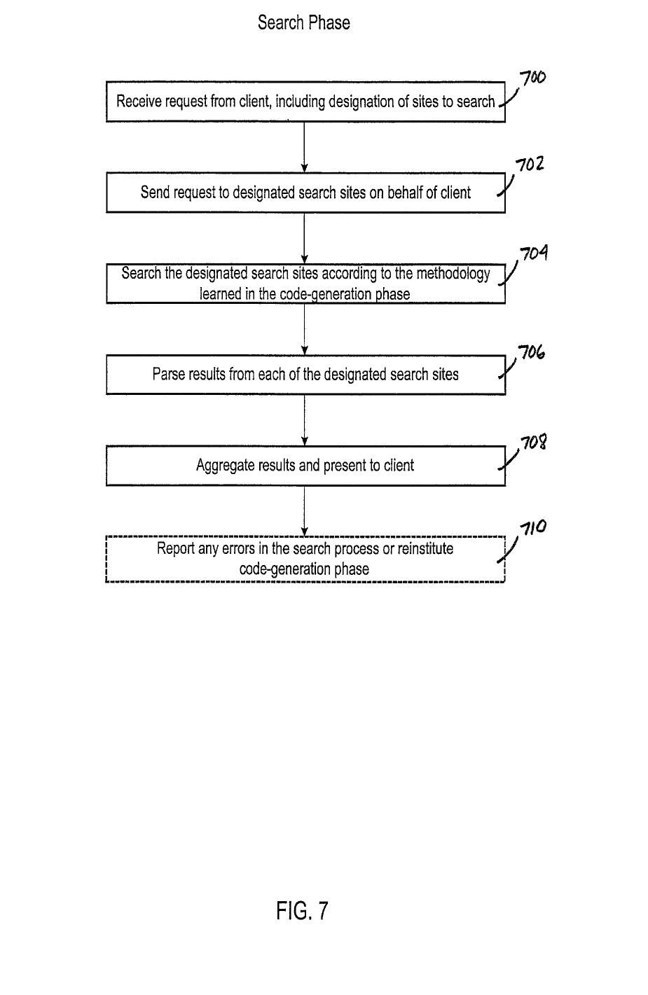

The processes of generating and implementing a search agent can be separated into two phases. The first phase is a code-generation phase. In the code-generation phase, the inclusion agent is employed to search the sites being learned according to that site's predetermined search methodology, identify the steps in the search methodology, and generate a customized search agent to implement the learned search methodology. The second phase is a search phase. In the search phase, the client can use the search agent generated during the code-generation phase to search the learned sites. FIGS. 6 and 7 illustrate the code-generation phase and search phase respectively.

FIG. 6 illustrates a flowchart of the steps involved in a preferred embodiment of the code-generation phase. With particular reference to FIG. 6, the process begins with the inclusion server sending a start request to a content server on behalf of a client 600. The inclusion server then receives a response from the content server 602 providing a Web page with an HTML form. The inclusion server replaces the action fields in the form elements with references to itself (i.e., the inclusion server) 604. The inclusion server records the original URL and miscellaneous information in HTML hidden fields for later use 606. The inclusion server then sends the modified response back to the client 608 and receives and records input from the client for conducting an appropriate search 610 based on the response. The input request is then sent to the content server 612, and a response from the content server is once again received by the inclusion server 614. The new response is then evaluated to determine if it is a results page 616. If it not a results page, the process returns to the step of replacing the action fields in the form elements with references to the inclusion server 604 and continues with the subsequent process steps. If a determination is made that the response is a results page 616, the process of the code-generation phase is finished 618.

Conducting a Search

FIG. 7 illustrates a flowchart of the process involved in a search phase consistent with a preferred embodiment of the present invention. With respect to FIG. 7, the search phase occurs subsequent to the code-generation phase and begins by receiving a request from the client including a designation of sites to be searched 700. The designation of sites to be searched can include any or all of the sites that were included in the code-generation phase. The search agent sends a request to each designated search site on behalf of the client 702. A search is conducted on each of the designated search sites according to the specific methodologies learned during the code-generation phase 704. The results from the search of the designated sites 704 are then parsed 706, and the parsed results are aggregated and presented to the client 708. As an optional step in the search phase, if any errors are detected in searching the designated sites, those errors can be reported to the client, or their presence can alternatively call the inclusion agent to initiate a new instance of the code-generation phase 710.

Preferred System Configuration

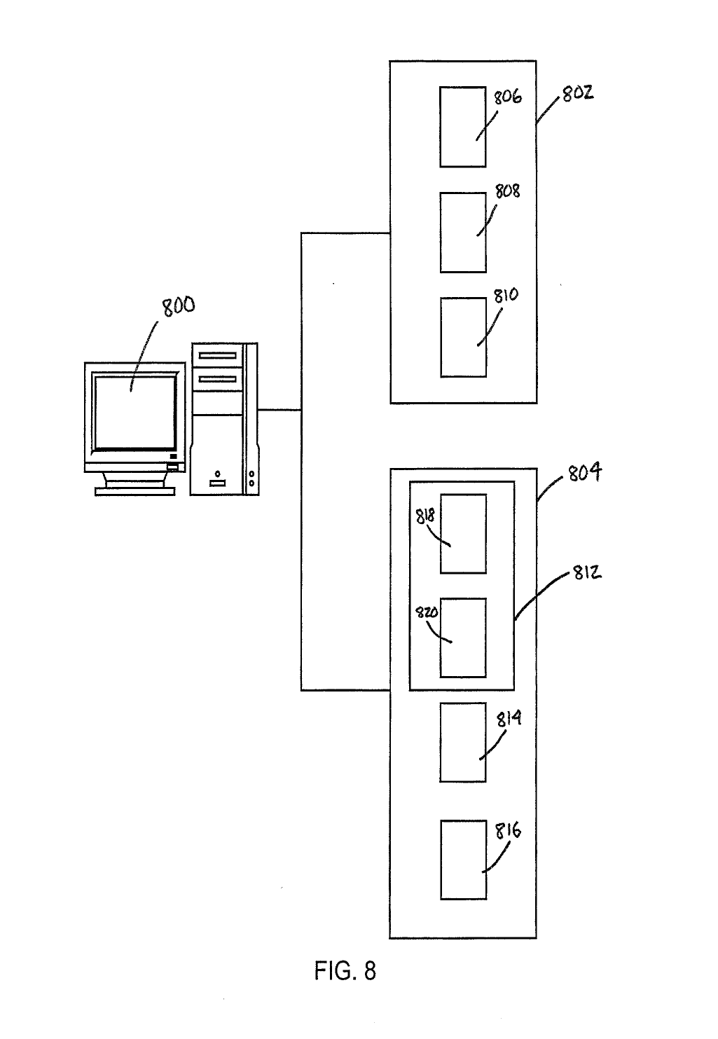

Consistent with the present invention, the functionality illustrated in FIG. 6 and FIG. 7 can be implemented by the inclusion server through one or more computer programs. In a preferred embodiment of the present invention, as illustrated in FIG. 8, the functionality of the inclusion server 800 can be implemented through two categories of computer programs or routines. The first category represents user-friendly interfaces 802. The second category represents code-generating scripts 804. Although the actual type or number of programs included for supplying functionality to the inclusion server 800 may vary, a preferred embodiment implements the programs as follows. First, a preferred embodiment can implement three Web pages for comprising the user friendly interfaces 802. Web pages are implemented in order to optimally facilitate use by a novice computer user. The novice computer user can use a standard network browser to view the Web pages, thereby easily interfacing with the functionality of the inclusion server 800.

The first Web page is a start Web page 806. The start Web page 806 receives information from the client including a URL or other identification of one or more Web sites to be learned as well as values for the parameter variables to start a search to identify the search methodology of a content server. The second Web page is a search Web page 808. The search Web page is used by the client after a search agent has been created. The search Web page 808 receives search parameter values from the client and then instructs the search agent to search each Web page learned by the inclusion agent according to the values provided by the client for the parameterized variables. The third Web page comprising the user-friendly interfaces 802 is a results Web page 810. The results Web page 810 is used to present the user or client with aggregate results from the one or more pages searched responsive to the client's search request in the search Web page 808.

In addition to the user friendly interfaces 802 are visible to the client, there are also code generating scripts, which are substantially hidden from view by the client. The term “script” is used to refer generically to a class of programs, such as CGI scripts, consisting of a set of instructions to an application or utility program. In a preferred embodiment, scripts can be used as a method of generating code and sending communications between a client and server across a network. Alternative forms of computer programing can also be implemented as known by those skilled in the art of client-server computer systems. In a preferred embodiment, the code generating scripts can be divided into three main types: an inclusion script 812, a code script 814, and a results script 815. The inclusion script 812 is used to record the search methodology used to search for content on one or more content servers. The code script 814 is used to store and implement the search methodology determined by the inclusion script 812. After content has been located on the content servers, the results script 816 is called to parse the search results and present them to the user in an aggregate format or HTML table supplied on the results Web page 810.

The inclusion script preferably comprises two separate routines; a first routine 818 and a second routine 820. The first routine receives the initial input from the client via the start Web page 806 and requests from each content server a first Web page supplying a search form for that content server. The second routine receives input from the client to complete the search form. The second routine 820 then submits the completed form data, receives a second Web page, and verifies that the second Web page is a results Web page. There are several methods by which the second routine 820 can determine the presence of a results page. For example, if the second Web page provides another HTML form rather than just information (i.e., the results), the second routine 820 can be repeated until the results page no longer returns a page with a form.

The previously described search heuristic interprets the lack of a form as indicating a results page. Other heuristics could also be used additionally or in the alternative to parse server responses and identify a results page. For example, interactive user input can indicate when a results page has been obtained. Also, the presence of certain types of data on a Web page, such as a defined HTML table, a URL or link, a dollar sign, or certain key words, can be interpreted as identifying a results page. As an example of the latter methods, content server results are often presented in an HTML table on a Web page. Tables are often organized to show the item for which the search was conducted along with pricing information and a link to access a Web page for obtaining the item. Often the tables include descriptive headings or the actual results are placed on the Web page proximate to predictable words or symbols describing the results. For example, a price result is often shown proximate to a dollar sign, and the result of a search for a particular type of automobile is often presented proximate to the words “make” or “model.” Parsing the Web page from the content server for the presence of these or other expected words illustrates a simple heuristic for identifying a results page.

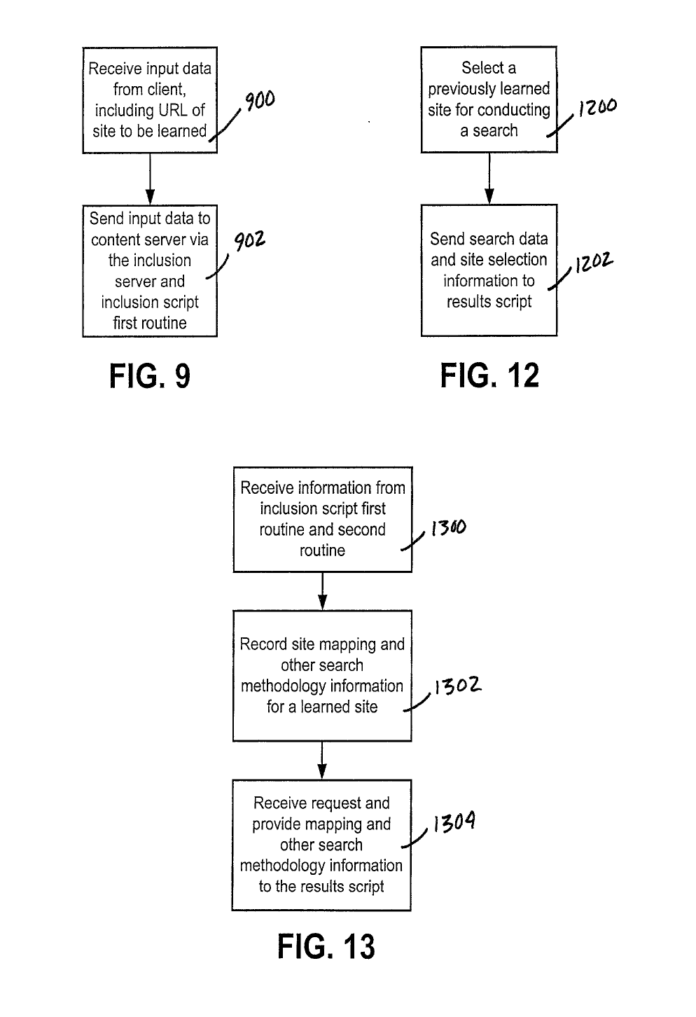

The functionality of the individual scripts and Web pages comprising a preferred embodiment of the present invention is further described with reference to FIGS. 9 through 15. FIGS. 9 through 15 depict flow charts illustrating the process steps that can be implemented by each of the separate programs within a preferred embodiment of the present invention. With respect to FIG. 9, the process steps for a start Web page are illustrated. First, a start Web page HTML form receives input data from the client, including the URL of the site to be learned 900. The start Web page then sends the supplied data to the content server via the inclusion server's inclusion script first routine 902.

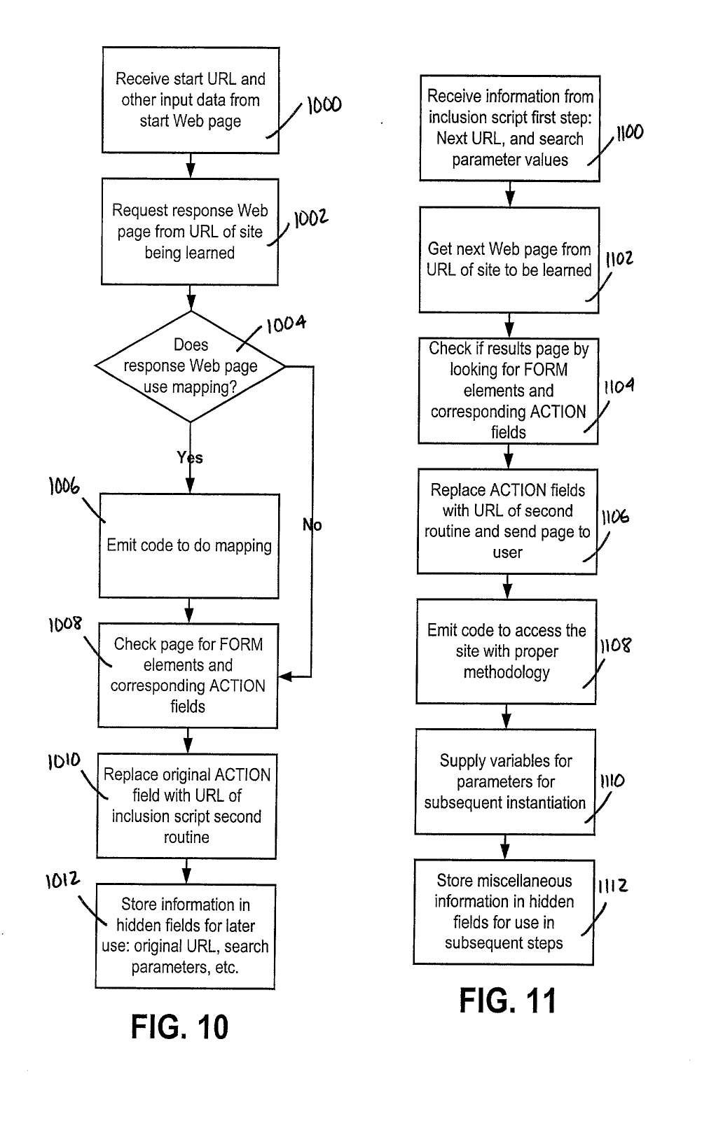

FIG. 10 illustrates process steps for the inclusion script first routine. The first routine begins by receiving the start URL and other input data from the start Web page 1000. In the preferred embodiment of the present invention, the URL refers to a search page on the site being learned. The start URL can be supplied manually from a user, or it can be supplied automatically from another program, applications, or other sources. Other information or data representing search content useful for conducting the learning search can also be supplied. The first routine then requests a Web page from the server at the URL of the site to be learned 1002. The inclusion script first routine, upon receiving the Web page from the site to be learned, extracts the base URL for inclusion as an option in the select field of the search Web page (FIG. 12) provided to the user for conducting subsequent searches. This allows the user to select that site for subsequent searching.

The first routine also determines whether the site being learned uses mapping, 1004. Mapping is defined as the occurrence of an HTML select field in which one of the option categories identifies the item being sought. If the site being learned uses mapping, the first routine identifies each of the option values within the select tag and emits code to do emulate the mapping 1006 for subsequent searches. The mapping can be performed through an array using the appropriate variables characterizing the search content. The first routine then checks the data comprising the Web page for the presence of form elements and corresponding action fields 1008. The original action fields are replaced with the URL for the inclusion script second routine 1010. The first routine also can identify the method, get or post, being used by the site being learned. Finally, the inclusion script first routine stores information in hidden fields for subsequent use 1012, including the original URL of the site being learned as well as specific data parameters for the search content. Other useful information can also be stored.

FIG. 11 illustrates the process steps for the inclusion script second routine (820 in FIG. 8). The second routine begins with receiving information from the inclusion script first routine including relevant search parameter values and the site being learned's subsequent URL extracted from the action field, 1100. The second routine then extracts the base URL for the site being learned and sends a request to the site being learned to receive the subsequent Web page 1102. Both get and post communications methods can be used. The second routine then checks the subsequent Web page to determine if it is a results page 1104. This can be done, for example, by searching for the absence of a HTML form element and corresponding action fields. If no form elements are found in the HTML code supplied by the site being learned, the second routine determines that the page is a results page. If form elements are found, the page is provided to the user for repeating the process until a final result page is determined. The second routine then proceeds by replacing the action field with the URL of the second routine and sending the page back to the user 1106. In this manner, the second routine can be called as many times as necessary until a results page is received.

Other methods, such as accepting user input or identifying the presence of a particular type of hyperlink, table structure, or certain key words or symbols, could also be used to identify the results page. Additionally, the results of a search are sometimes organized in such a way that they require more than one Web page for display (i.e., the user is presented with multiple results pages and must select a link, such as a “Get more results” link, or a GUI button, such as a “Next” button, to view them in their entirety). Embodiments of the present invention can determine this fact through methods such as user input or recognition or a particular markup language syntax, tag, or key word or combination or words. The methodology required for viewing the results can then be taken into account when emitting code to enable subsequent searches of the learned site.

Continuing with FIG. 11, the second routine emits code to access the site with the proper search methodology 1108. The search methodology is written to the code script. The second routine also writes a procedure to the results script code to correctly parse the results. As the second routine writes code to access the learned site with the proper search methodology, the second routine also supplies variables for the search parameters 1110. These variables are instantiated at a later time in response to a request from the client to search a previously learned site for content. For example, if the user is developing a customized search agent to search for used cars for sale on the Internet, the user can include one or more sites offering user cars for sale. The user can initially conduct a search on a site using a particular make or model, such as a Volkswagen Passat. While the user searches containing the desired automobile, the search methodology for that particular site is identified and recorded. The search methodology is then implemented in code in the customized search agent to enable subsequent searching of that site by the user. However, because the customized search engine needs to be able to search that site for any type of automobile, the words “Volkswagen” and “Passat,” as they are implemented in the search methodology for the site, can be substituted in the search agent code by the variables “make” and “model.” The actual search values for the variables can be accepted from the user when the search agent is run. For example, the user can conduct a search for a Buick LeSabre, and the variables “make” and “model” will be instantiated at the time of the search to conduct the search methodology with the values “Buick” and “LeSabre” instantiating the “make” and “model” variables respectively.

The type, name, or number of variables assigned for conducting a search can be predetermined based on the type of content for which the search agent will search, or they can be determined heuristically during the course of the initial search for learning the search methodology of a site. The task of initially declaring variables alternatively can be distributed to the user conducting the search.

Finally, the second routine also stores miscellaneous information in hidden fields for subsequent use 1112. Examples of stored information include original URLs for the site being learned, as well as search parameter values supplied for the various form elements.

FIG. 12 illustrates steps conducted by the search Web page. The search Web page begins with the client selecting a site that has been learned through the inclusion script first routine and second routine 1200. In a preferred embodiment of the present invention, the selection is made using an HTML select field with an option value provided for each site learned. A preferred embodiment also has an option value provided to select all sites learned. The search Web page then sends the site selection and other search parameter data or values to the results script 1202, as indicated in the action field for the search Web page.

FIG. 13 illustrates the process steps for the code script. The code script begins by receiving information form the inclusion script first routine and second routine 1300. The code script then records site mapping and other information represented in the search methodology for a site being learned 1302. Finally, upon request, the code script provides mapping and other search methodology information to the results script 1304.

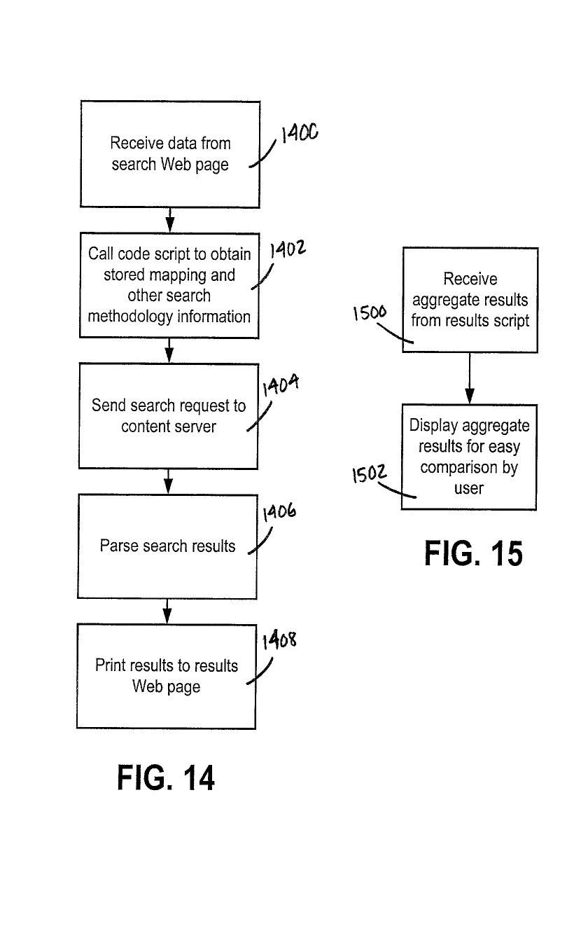

Process steps included in the result script are illustrated in FIG. 14. The result script begins by receiving search data from the search Web page 1400. The result script then calls the code script for site mapping and other search methodology information that has been stored 1402. The result script sends a request to the content server 1404 and parses the search results 1406 using a universal parser. The universal parser is a program that can extract content from HTML tables. It can be coded from scratch, or one of several commercially available universal parses can be used. The parsers can be coded in any general programming language, such as Java, C, C++, Perl, or the like.

Finally, the result script prints the results of the search from the one or more content servers to the results Web page 1408 in an aggregate form. The results can include informational data as well as links or similar references, files, or digital content. The results script can incorporate certain optimization assumptions. For example, one assumption can be that the results are presented in an HTML table. Because there can be several tables on a Web page, the results script can assume that the results table is the one in which the search parameter values are provided, often in a predetermined, recognizable format. One example of a predetermined, recognizable format would be the occurrence of the terms “make” and “model” proximate to a link in a table, if the search was for a used car. Similar other formats could be used depending on the subject matter of the search.

As previously discussed, other assumptions can be adopted to identify a results page. One example is assuming that a number next to a dollar sign is a price. Recognition of a results page can also be a task delegated to the user on an interactive basis. In an alternate embodiment accepting user input to identify a results page, a user is provided an interface comprising an HTML frameset. The user can surf the site being learned in the main frame of the frameset while using navigation or input tools in adjacent frames. The user can indicate when a results page has been obtained, and he can even indicate where on that page the results are presented (for example, a certain row or column of an HTML table).

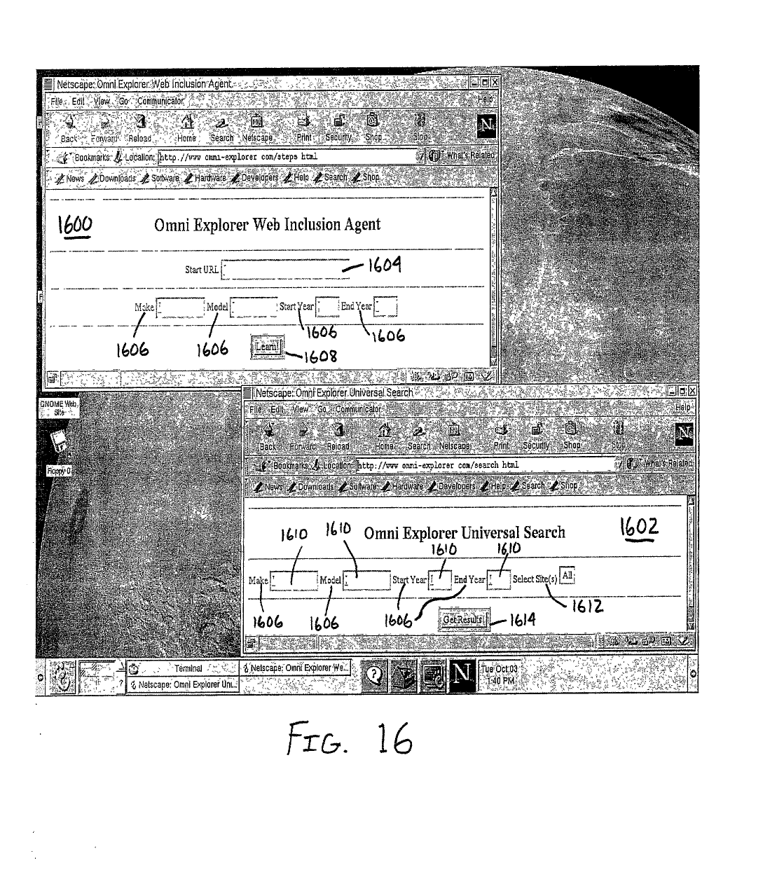

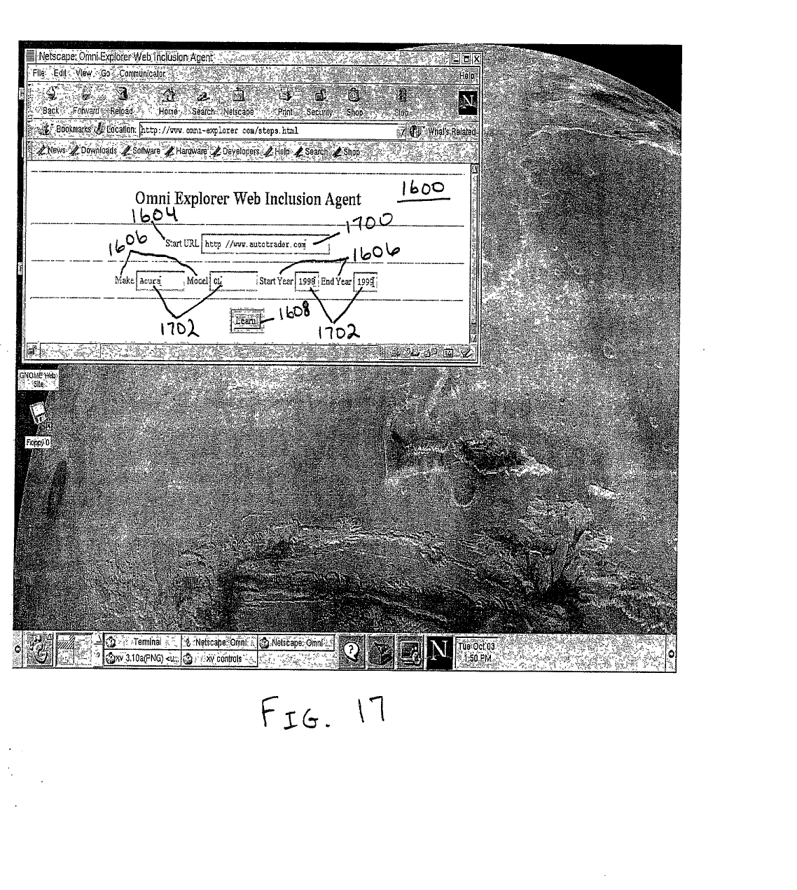

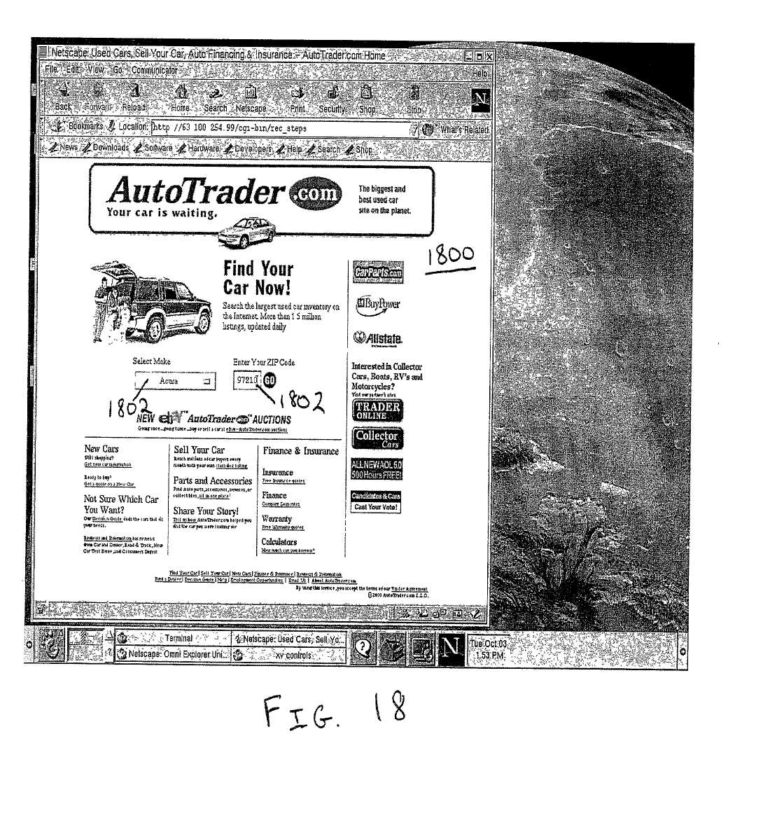

As illustrated in FIG. 15, the presentation of a results Web page begins with receiving aggregate results from the result script 1500. The results Web page then displays the aggregate results for easy comparison by the client 1502. In a preferred embodiment, the results Web page is generated by the result script and the HTML code is written with respect to the actual results obtained.

One advantage of the present invention is that it provides a novice computer user with a greatly simplified ability to generate code defining a search agent for searching one or more Web sites in an automated manner. User-friendly interfaces hide the more sophisticated code-generating scripts stored on the inclusion server. From the user's point of view, all he has to do is surf a series of Web sites for content. By virtue of doing the search, the user is able to implement the codegenerating scripts on the inclusion server to generate a search agent for use in automating subsequent searches.

Another advantage of the present invention is that it can enable rapid collection of aggregated results by enabling distributed collaboration. For example, a plurality of users can access the inclusion agent and identify different sites to be learned. The output from the inclusion agent can then consolidate all of the search methodologies into a single search agent, so that the one search agent can search each identified site. In this manner, the multiple efforts of several remote users can be consolidated into a single, useful output, thus increasing the breadth of the search agent's abilities while decreasing the time required to generate it. Also, as another form of collaboration, several users can use the same search agent (or several search agents) to run independent search request on any or all of the sites for which a search methodology has already been learned. The results of the independent searches can then be aggregated into a single results page. As an example of how this embodiment could be implemented, the search agent or agents could be coded with simple CGI script instructions to write the results of a search to a common database. Any time a results page is requested for the appropriate search parameters, the aggregated contents of the database may be read out and displayed on the results page.

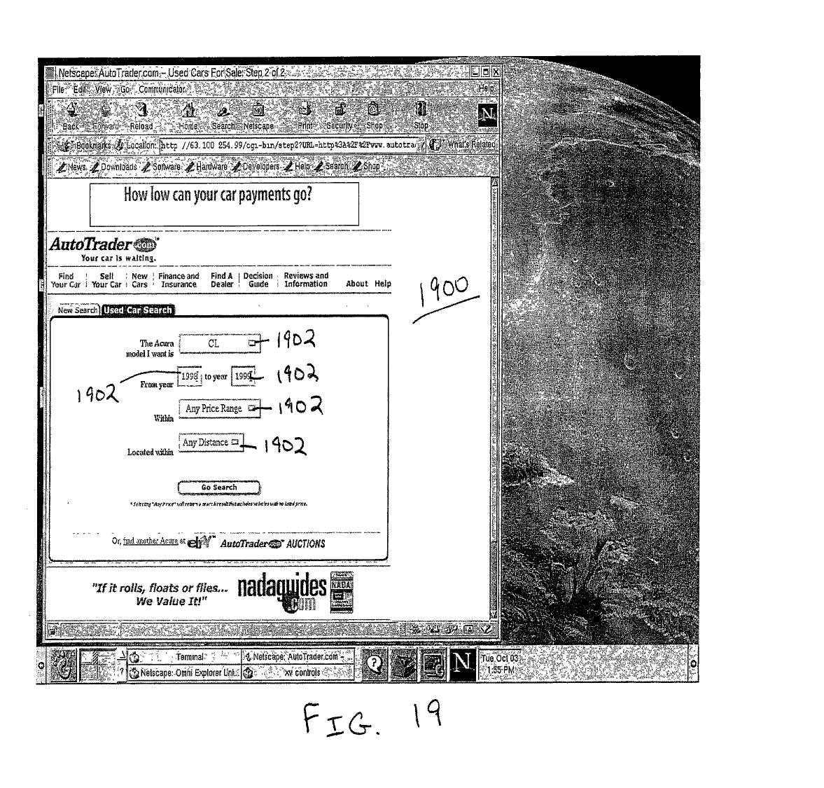

FIGS. 16 through 33 illustrate examples of the Web pages visible to a computer user when implementing a preferred embodiment of this invention. The description of FIGS. 16 through 33 shall proceed with reference to one example of an implementation of the present invention. In the proffered example, the invention is implemented in a search for online automobile sales. Specifically, the example illustrates implementation of the invention in the context of a consumer's search for used cars via the Internet. However, the example in the car industry is for illustrative purposes only. Also, the illustrative search can represent a B2B or B2C transaction. The user-client can be a consumer, or it can be another car dealer searching the inventory of an affiliate dealers' sites.

While the illustration of a preferred embodiment is in the context of a car sale, implementations embodying the present invention are not so limited. The present invention can be used to search for any type of content on a network, so long as the content can be adequately parameterized or characterized. For example, cars often appear under characteristics of “make” and “model.” A search can also be conducted for music under the characteristics “artist” and “title,” or “album” and “title.” The actual names of the variables are not important. What is helpful is that the content being searched can be objectively characterized to the extent that it can be located substantially in an expected format. Other examples may include names and phone numbers or URLs; dictionary or encyclopedia entries and corresponding definitions; audio, video, or other files; news stories; diseases and symptoms; or other types of content commonly available via a network (such as the Internet).

Continuing with the example of a car search, FIG. 16 illustrates two primary Web pages used by a novice computer user as interfaces to the inclusion server of the present invention. FIG. 16 illustrates both a start Web page 1600 and a search Web page 1602. Illustrated within the start Web page 1600 are form fields for providing a URL of a site to be learned 1604 as well as for providing initial values for search parameters 1606. In this illustrative example, the parameter variables (“make,” “model,” “year,” etc.) are predefined. The initial values supplied for these variables can be default values. Having values for which results are likely helps ensure that a final results page will contain substantive content, thus illustrating the completion of the search methodology. The user can also define these variables.

Once the parameters are supplied, the user selects the control to begin the learning and inclusion process 1608. Similarly, after all desired sites have been learned and their search methodologies included in the search agent, the search Web page 1602 provides the user with form fields 1610 to provide variables instantiating the search parameters 1606 by which the search is to be conducted on the learned sites. The user is also provided with a control 1612 to select any or all of the sites to be searched. Once the data is provided, the user can select the get results control 1614 to conduct the search.

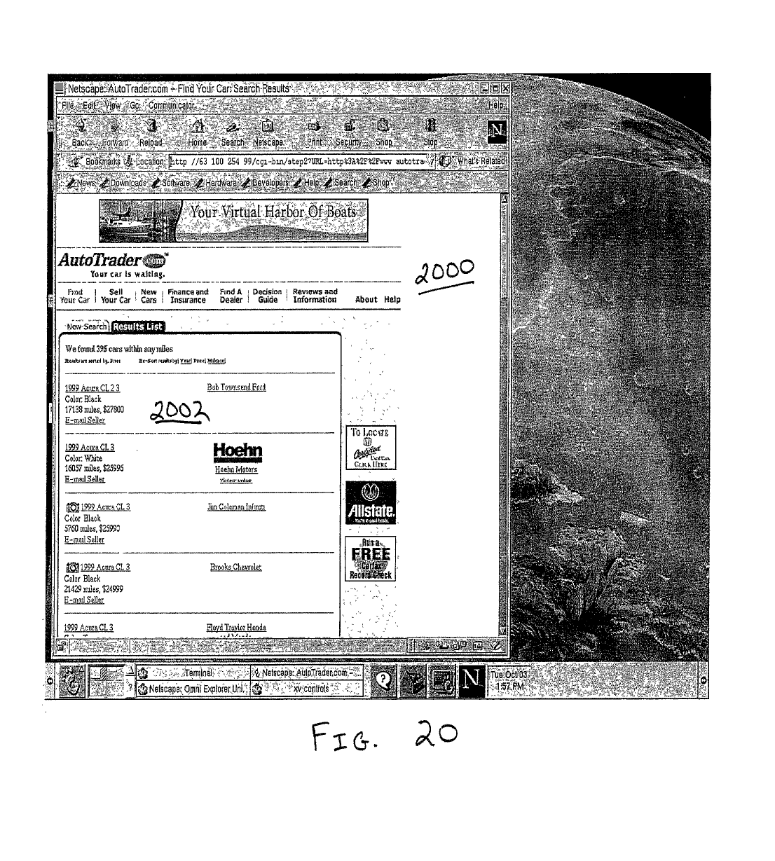

FIG. 17 illustrates the start window 1600 of FIG. 16 in which a user has provided a start URL for the form field indicating the site to be learned 1604, as well as initial values 1702 for the search parameters 1606. This data is then transmitted to the inclusion server and subsequently sent as a request on behalf of the user to the content server. The next page that the user views is the response page generated by the content server and returned via the inclusion server to the user.

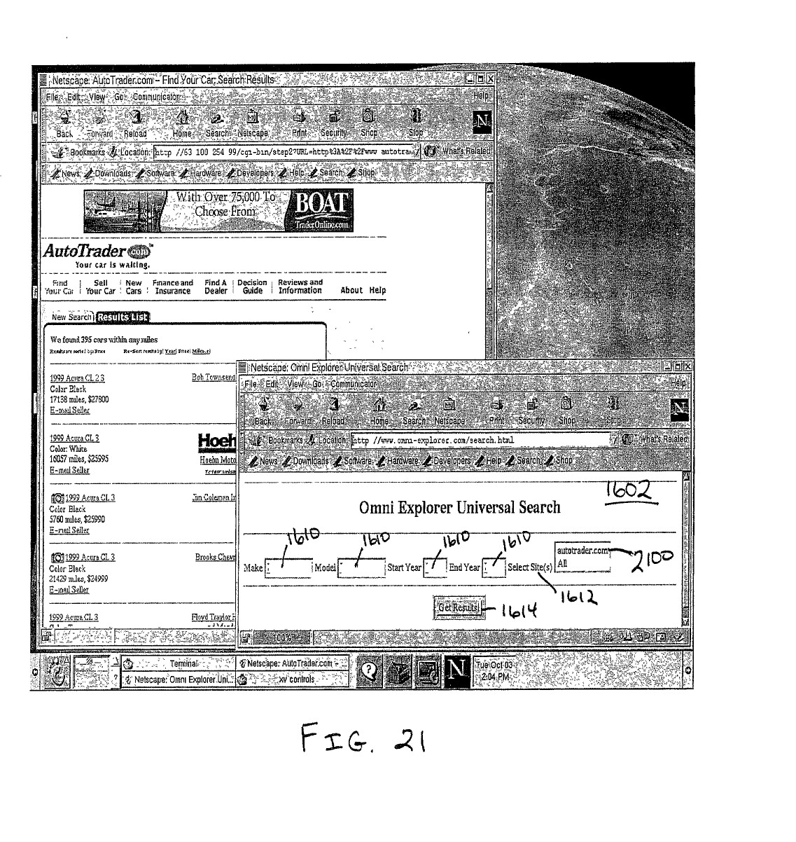

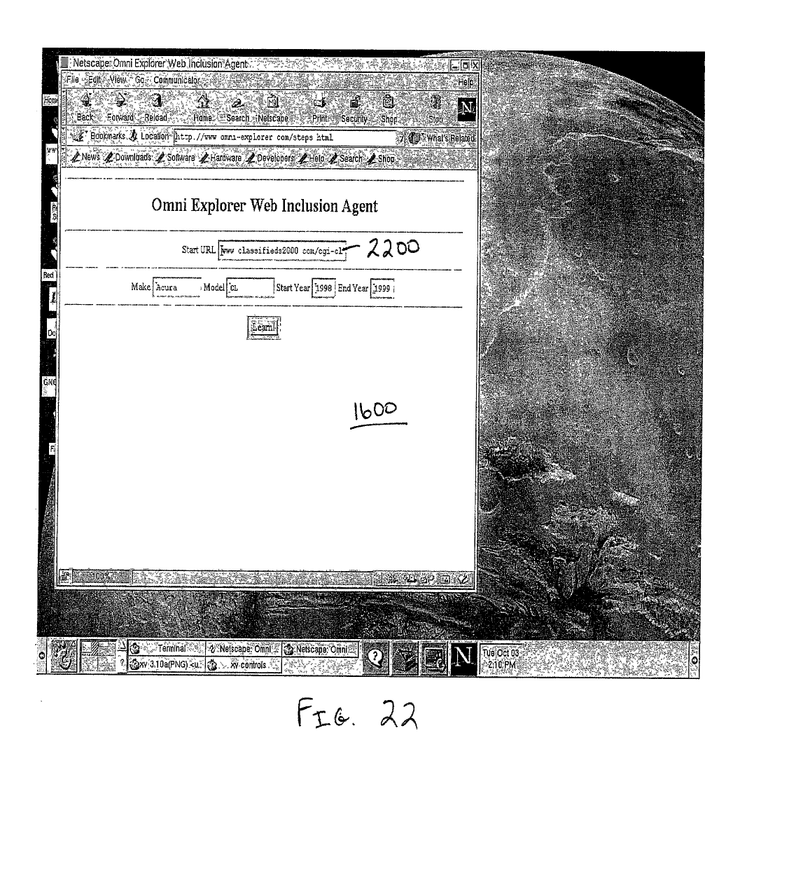

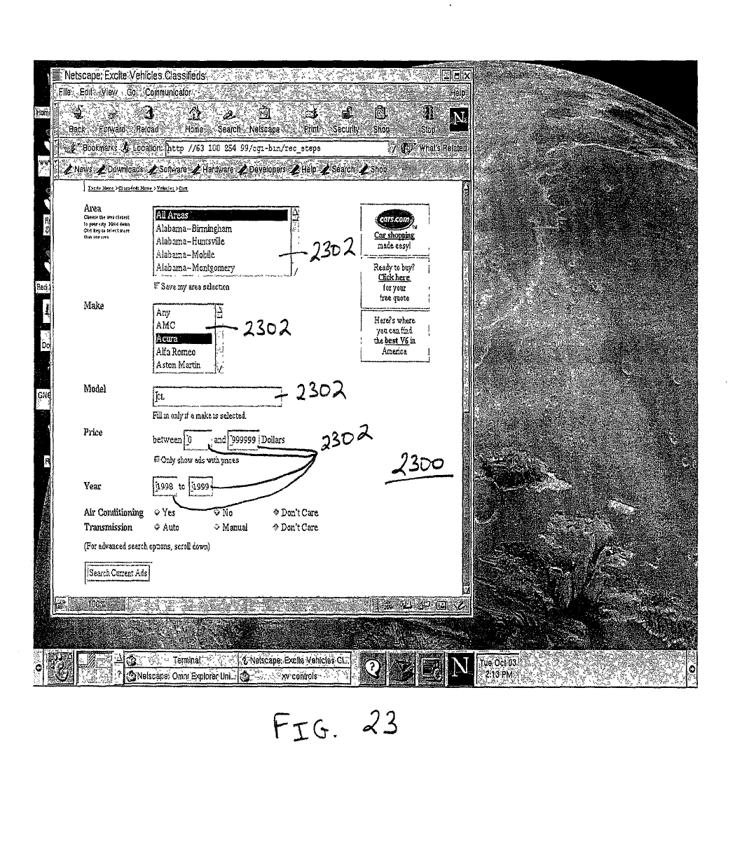

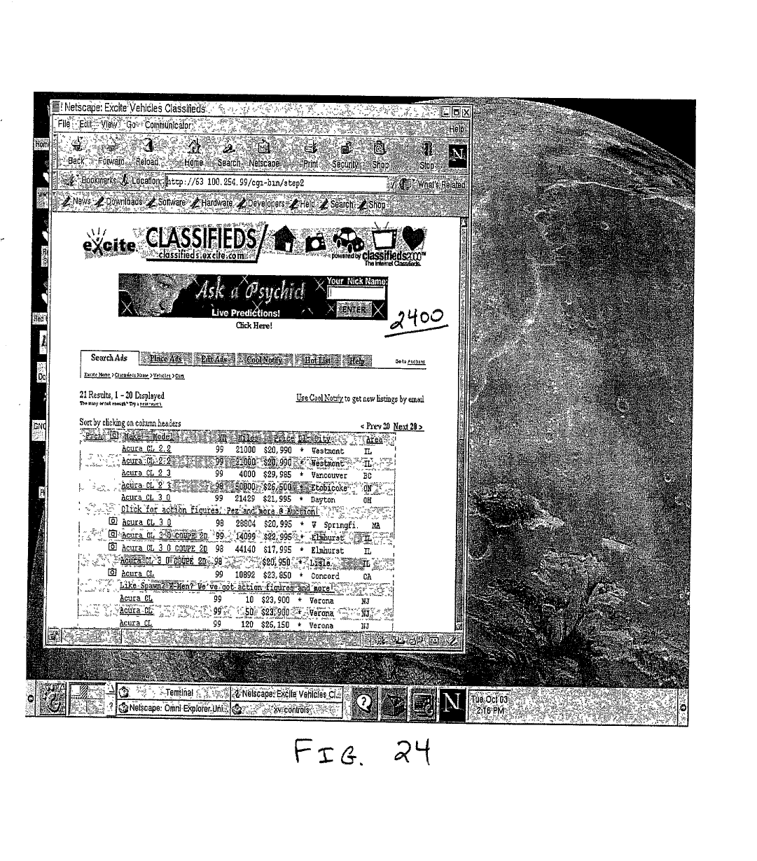

FIG. 18 illustrates a first response Web page 1800 with additional form elements 1802. The first response page 1800 is provided to the user to fill in the form elements 1802. Next, the user sends the information through the inclusion server to the content server in order to request a subsequent response page 1900, as illustrated in FIG. 19. The subsequent response page 1900 also has form elements 1902, and it is therefore determined that it also is not a results page. The process once again repeats and the communication is again monitored between the user and the content server. The final response page 2000, as illustrated in FIG. 20, lacks form elements and presents the final results in a table 2002. The learned site 2100 is now added to the site selection control 1612, as illustrated in FIG. 21.

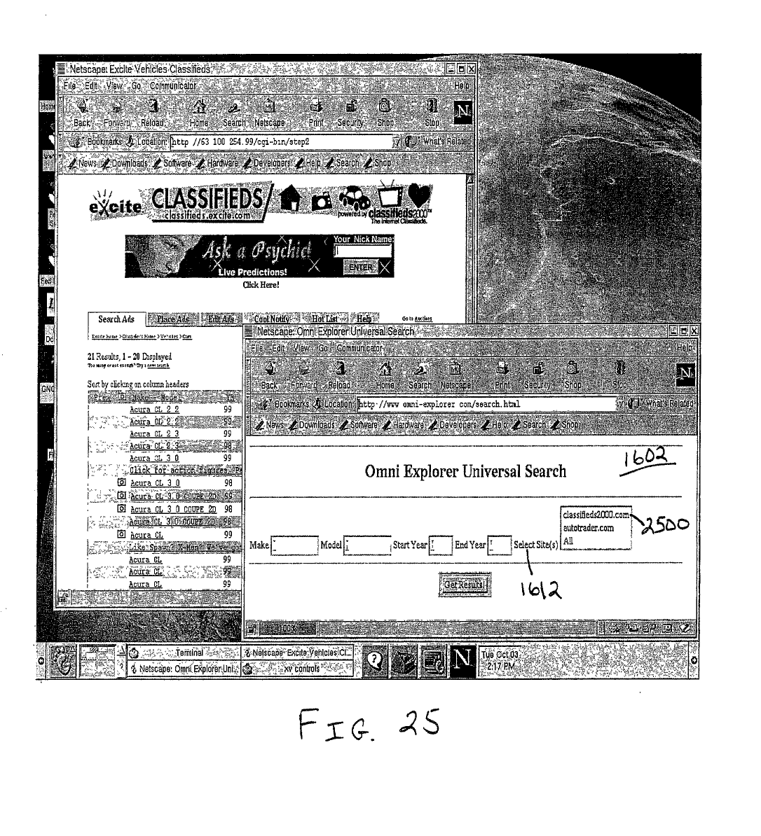

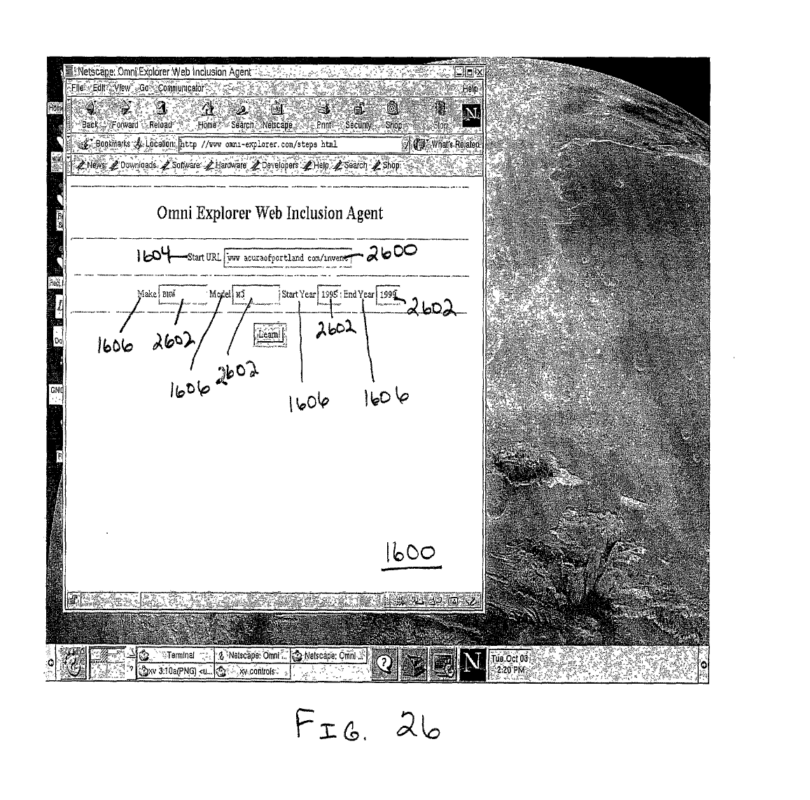

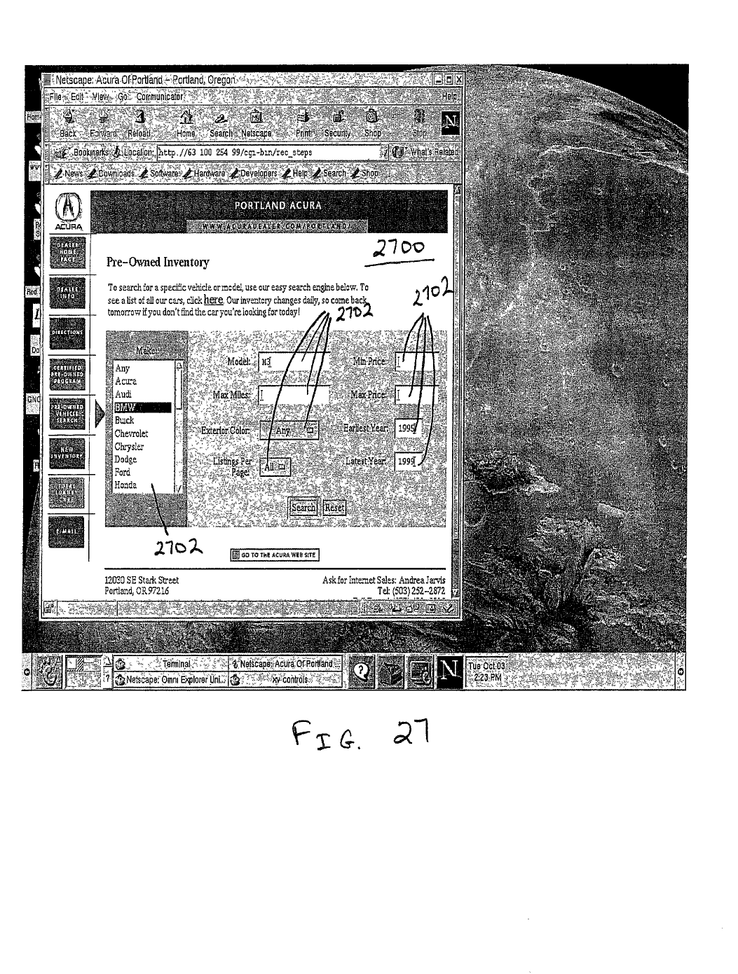

While this process illustrates how a single site of a content server can be included into the inclusion agent, the user can also repeat the process for multiple content servers. FIG. 22 again illustrates the start Web page 1600 in which a second site URL 2200 has been indicated. The user is again provided an initial response page 2300 with form elements 2302 as illustrated in FIG. 23, and the user supplies data to fill in the form. The data is again provided in a request to the content server and a subsequent response page is provided for the user. The subsequent response page 2400 is illustrated in FIG. 24. Because the located values are outside the presence of form option elements, the page 2400 is determined to be a final results page. Once the search methodology has been determined for the second site, the second site is also included 2500 in the search Web page 1602 in the site selection control 1612, as illustrated in FIG. 25.

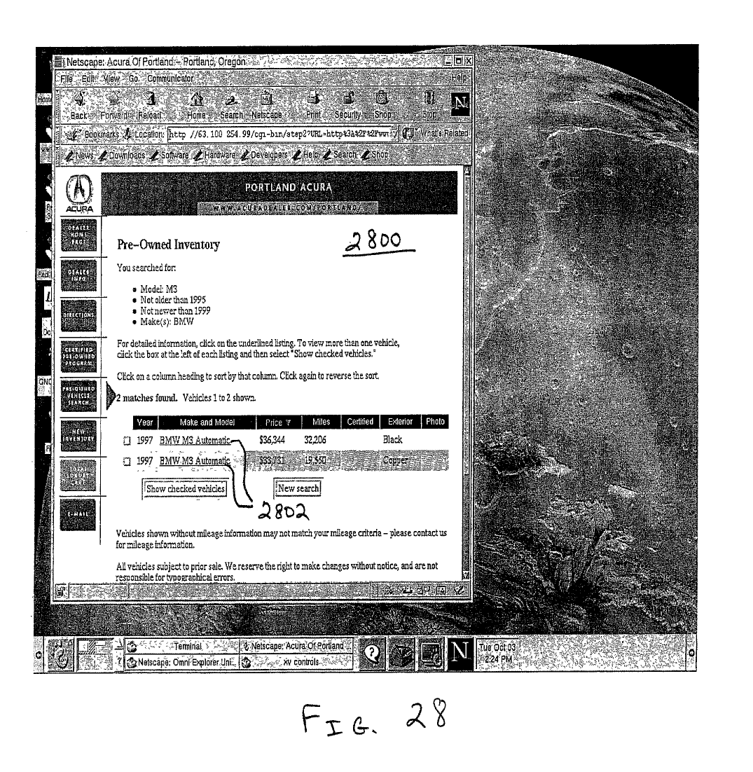

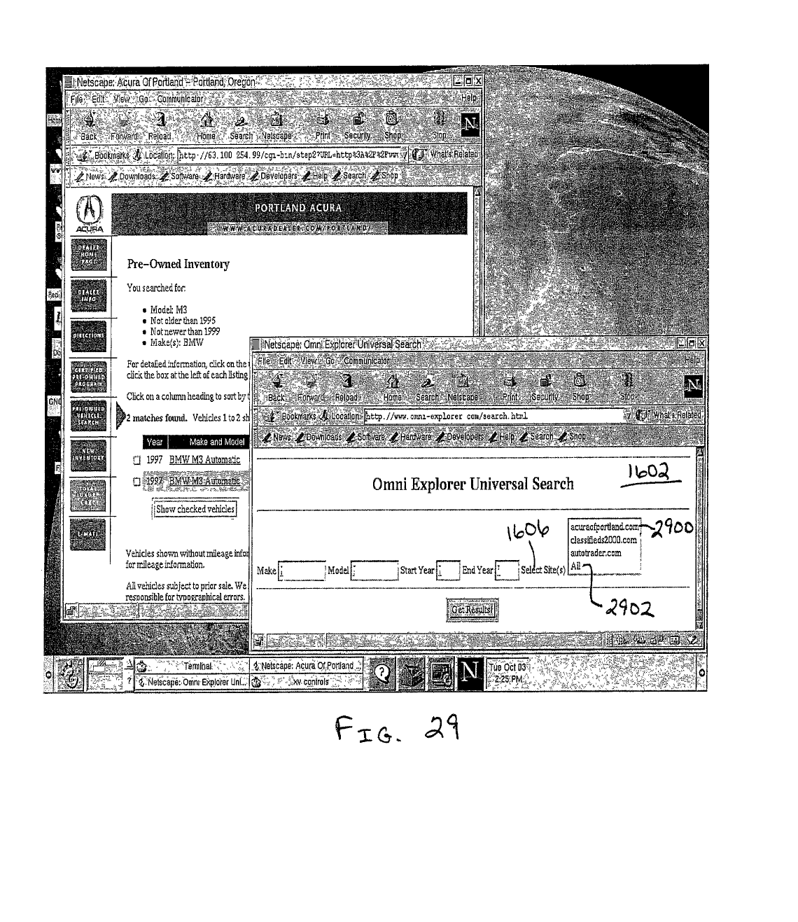

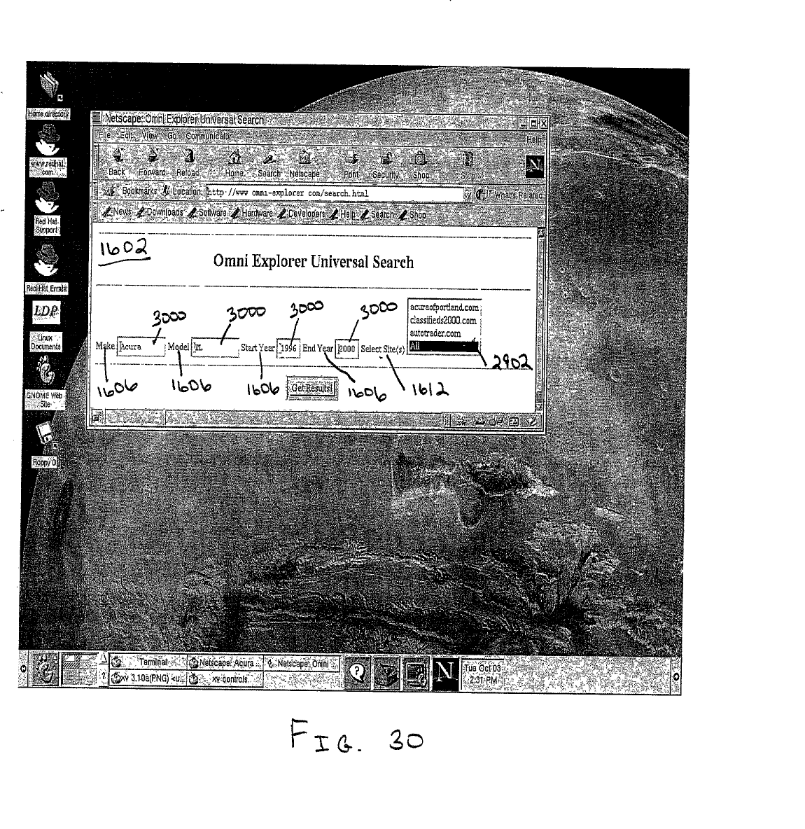

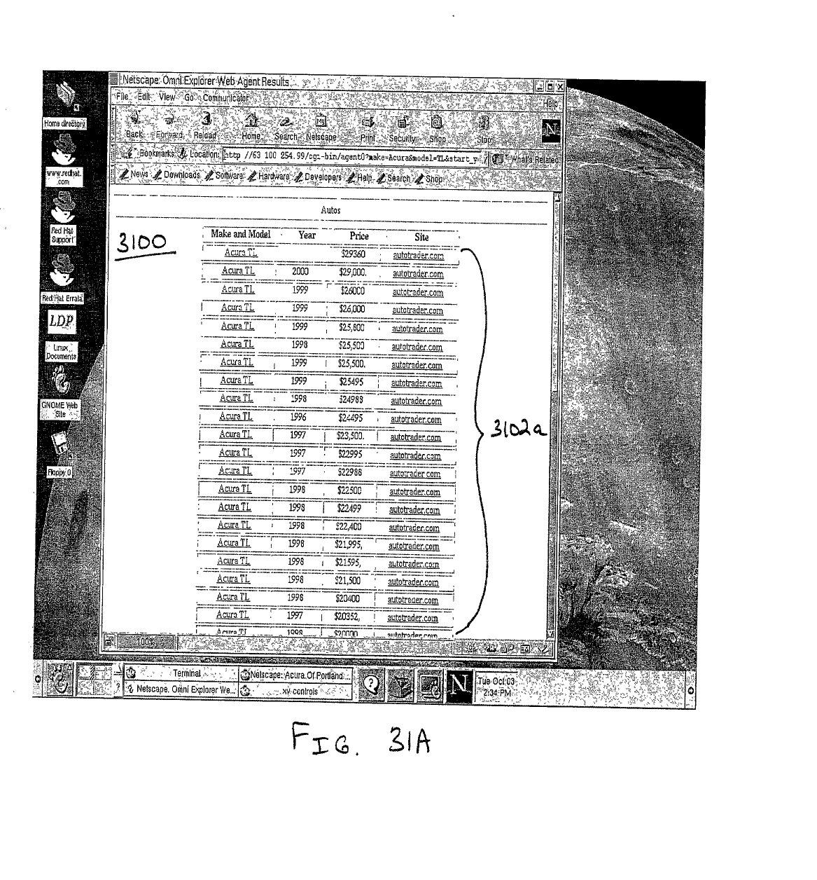

FIG. 26 illustrates the inclusion of a third site in the inclusion agent. The URL for the third site 2600 is supplied in the form field for the site to be learned 1604. Additionally, in FIG. 26, new values 2602 have been supplied for the search parameters 1606. The code-generating scripts next proceed to search the indicated content server for the new values 2602 for the search parameters 1606. The user receives a response page 2700 as illustrated in FIG. 27, the response page also having form elements 2702. As in the prior steps, data is supplied completing the form elements 2702 and a new response page 2800 is received from the content server as illustrated in FIG. 28. Because the values being sought 2802 are in a table and not present within a form element, the response page 2800 is determined to be a final results page and the learned site is also included in the inclusion agent. The new site 2900 is included in the site selection control 1612 of the search Web page 1602 as illustrated in FIG. 29. FIG. 29 also illustrates an option 2902 within the site selection control 1612 for selecting all of the learned sites for subsequent search.

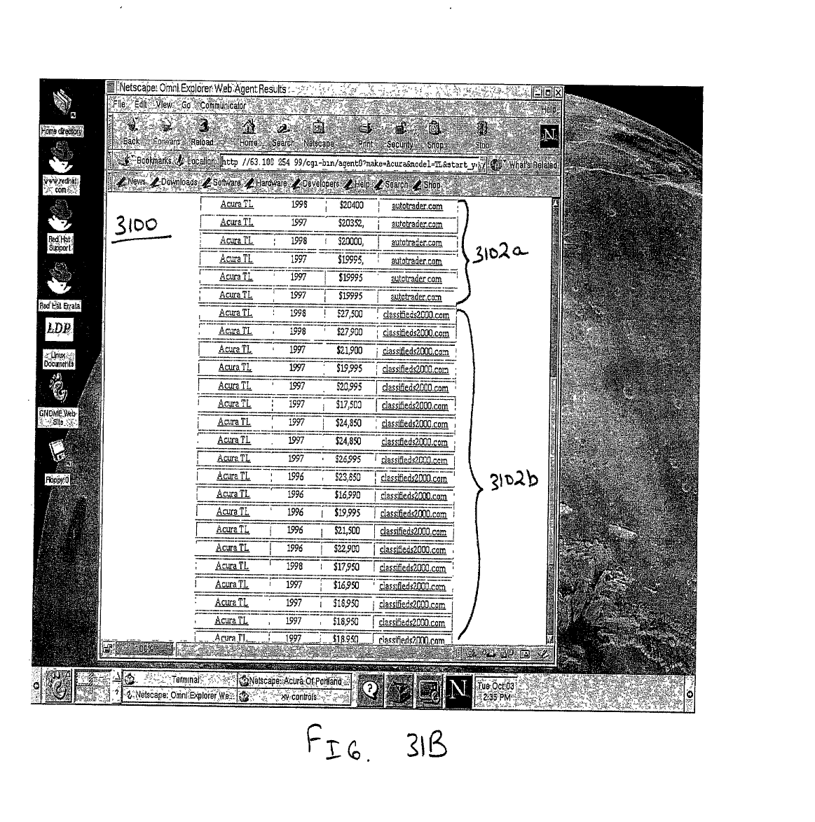

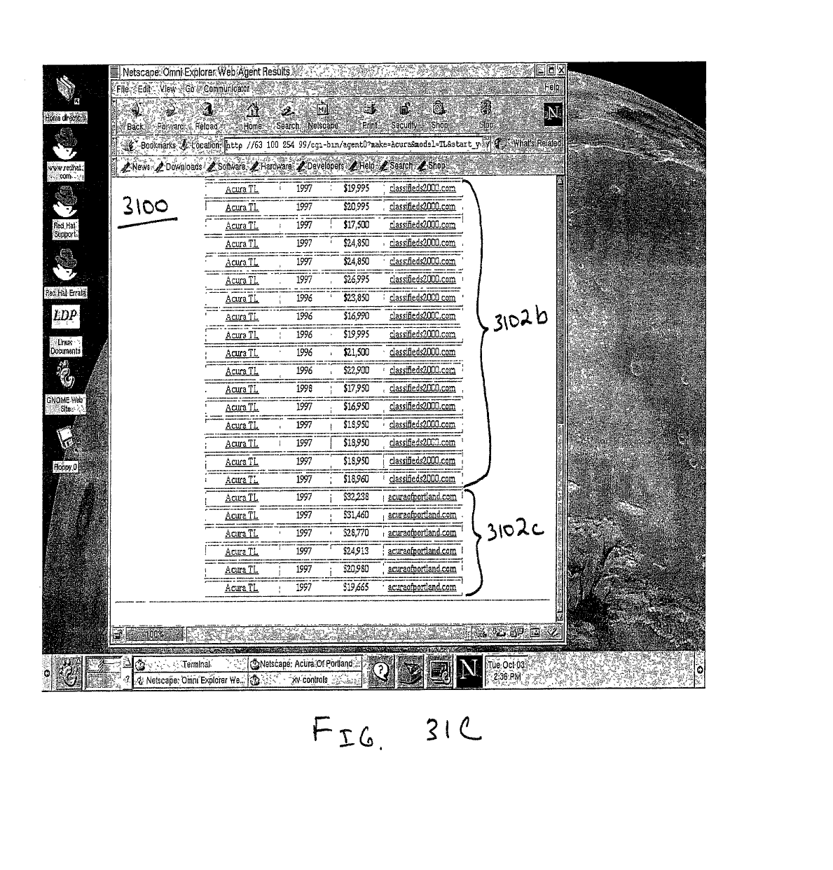

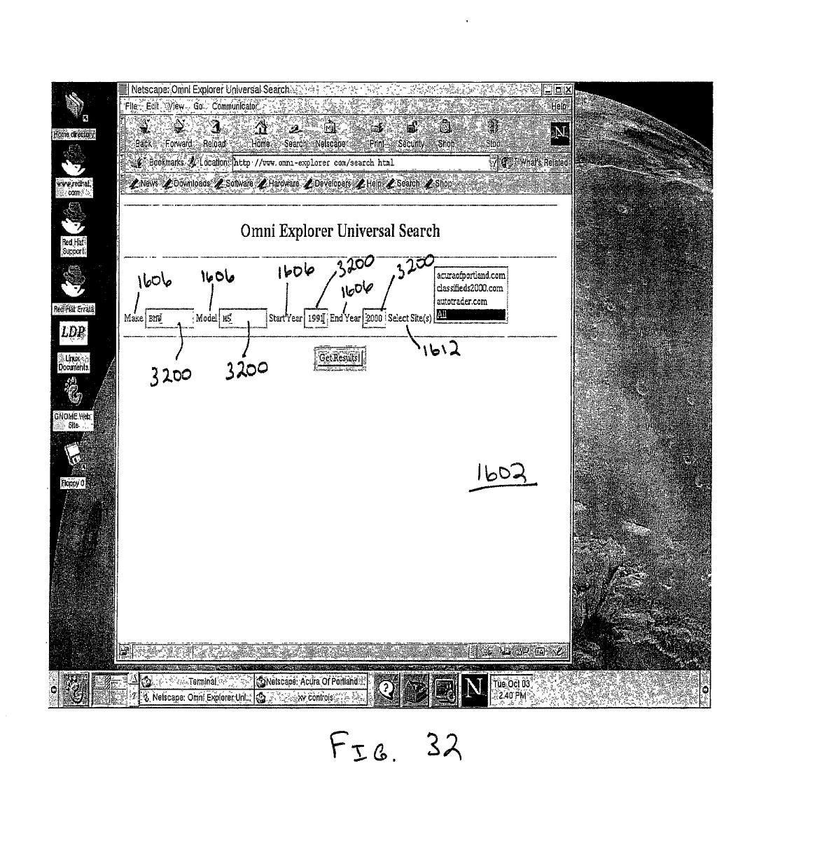

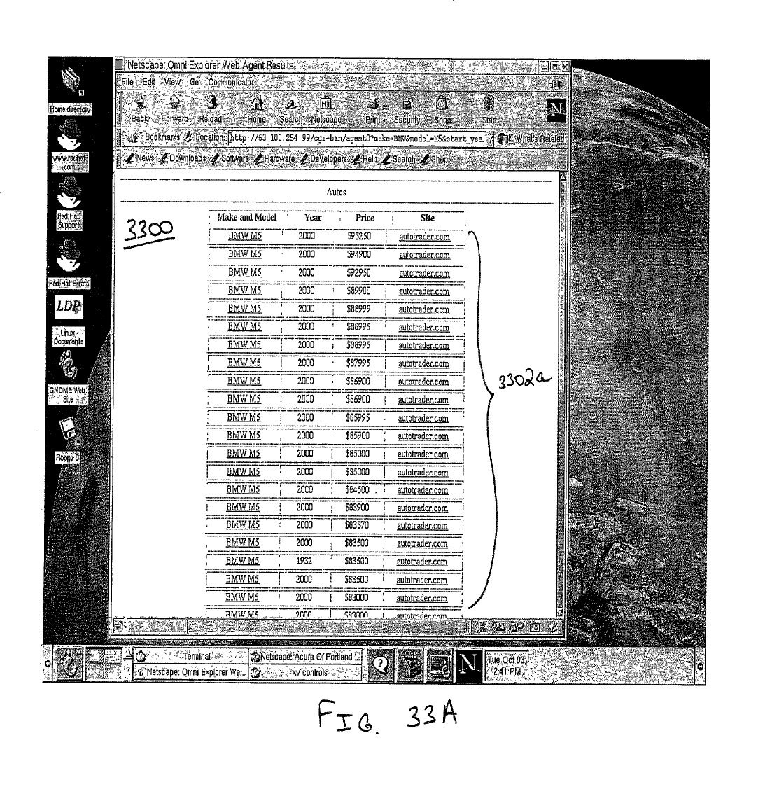

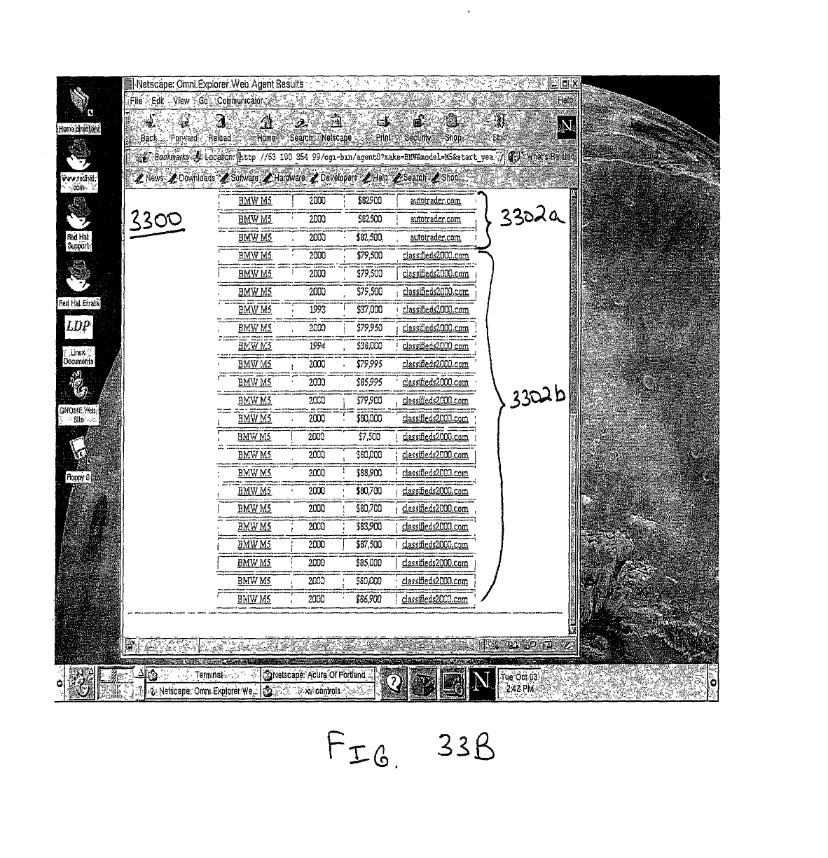

FIG. 30 illustrates the search Web page 1602 of FIG. 16, in which a new search value 3000 has been provided by the user to instantiate each of the search parameters 1606. FIG. 30 also illustrates the instance where the user has selected the “all” option 2900 from the site selection control 1612. The results script then calls the code script to implement the necessary mapping and other search methodology information determined by the inclusion script while the sites are being learned, and a search is conducted on each of the sites that were learned in the prior steps. The information that is obtained from this search of the content server sites is supplied to the results HTML from the results script. FIGS. 31A-31C illustrate an example of the results Web page 3100 containing tabularized, aggregate results from each of the included sites 3102a to 3102c. As illustrated with the preferred embodiment of the present invention, one particular aspect of the present invention is the ability to search for any content on a site once the site search methodology has been learned with respect to one instance of that content. For example, FIG. 32 illustrates the instance where a new value 3200 is inserted for each of the initial search parameters 1606. Because the inclusion agent has determined the search methodology implemented by each of the sites learned, the new search values 3200 can be instantiated for the search parameter variables and the sites can be searched for the new search values 3200. FIGS. 33A and 33B illustrate the aggregate results displayed in the results Web page 3300. The aggregate results show the content for which the search was conducted organized according to the site from which the content was gathered 3302a and 3302b. Also, as illustrated in FIGS. 33A and 33B, if a content server does not have content satisfying the request from the user, the aggregate results will be displayed without an entry for that content server.

In a preferred embodiment, because communications occur over a network and conform to standard HTTP procedures, the fields used in the search methodology for a given site will rarely change. However, if, for some reason, a content server cannot be accessed, access is denied, or the search methodology otherwise is not able to obtain a result, a preferred embodiment of the present invention provides notification to the user that the particular site needs to be relearned. This notification can include a error message displayed in an alert window, an e-mail notification, an error message appended to the search results in the results Web page, or other types of notification known in the computer arts.

An alternative embodiment of the present invention employs a near-completely automated learning process. This automated learning process can also be employed to relearn a site if results become unobtainable as mentioned above. In an alternative embodiment, the user does not have to manually surf a Web site to include the site in the search agent; the learning and inclusion process can be automated. As an example of an automated search, an alternative embodiment of the present invention can employ a standard Web crawler, spider, bot, or other or search engine to search for Web pages that contain particular keywords in text. Next, the alternative embodiment can search the page for an HTML form element indicating that the page is probably a search page. The alternative embodiment can then attempt a search by trying to detect an HTML select field in the form element with an option value corresponding to the value for the content being sought. A search can also be conducted to parse the page to identify the occurrence of words commonly used to characterize the content. For example, a search could identify the occurrence of the words “make” or “model” for a car search. Once such a value is located, code for mapping can be emitted and the process continued as in the prior, manual-inclusion example.

The benefits of the automated process is that it is easier to use and involves less human time and effort. The efficiency of the automated process can be optimized by employing inclusion agents to search for items that are in a particular industry or have well defined parameters or content characteristics. Examples include such things as makes and models for cars, or manufacturers and products for electronics, etc.

Alternative embodiments of the present invention can also employ common local caching techniques for generated results. Such techniques can be of use when commonly conducting repetitive searches, as they save time by not having to reacquire all of the results data each time a search is conducted. This allows an embodiment of the present invention to optimize the tradeoffs between response time, accuracy, and bandwidth considerations for a particular client, content server, or network connection. Often server update-rate can be the determinative factor.

As will be evident to those skilled in the art, alternative embodiments to the foregoing description may be employed while remaining firmly within the scope of the present invention. One such deviation relates to the nature of the code generation process used to generate the customized search agent. The prior description presumes a paradigm in which code is generated and stored in an external file to be run at a later time. However, the present invention could also be embodied through adopting a more object-oriented format. For example, an object can be instantiated based on a learned search methodology and stored in memory. The object can then be called to dynamically generate a search agent or conduct a search. This type of embodiment illustrates how the present invention would operate when implementing an object-oriented programming language such as Java or C++.

It should also be noted that the present invention would work with other types of markup languages. For example, in addition to operating with Hypertext Markup Language (HTML), the present invention can also operate with other markup languages, such as Dynamic Hypertext Markup Language (DHTML) or Extensible Markup Language (XML). Markup languages in which the particular meta tags used depend on a predefined schema can facilitate the operation of the present invention because the tags are often defined in a descriptive manner that simplifies identifying and parsing a results page.

It will be obvious to those having skill in the art that many other changes may be made to the details of the above-described embodiment of this invention without departing from the underlying principles thereof. The scope of the present invention should, therefore, be determined only by the following claims.

1. A method for enabling a client system coupled to the Internet to search for and aggregate content from a Web site on a content server coupled to the Internet, the method comprising the steps of:
providing an inclusion server coupled to the Internet;
routing communications between the client system and the content server through the inclusion server;
in the inclusion server, identifying a search methodology from the communications between the client system and the content server; and
generating a search agent to implement the identified search methodology.

2. The method of claim 1, wherein the search agent incorporates a content variable for instantiation by the client.

3. A method for enabling a client system coupled to the Internet to use a Web browser to generate a search agent to search for and aggregate content available on at least one of a plurality of Web sites, the at least one of a plurality of Web sites being hosted on a content server coupled to the Internet so as to provide the content to the client system, the method comprising the steps of:
coupling an inclusion server to the Internet;
establishing a first communication session between the client system and the inclusion server;
receiving, by the inclusion server, a first search request from the client containing a URL for the content server;
including the URL in a search agent hosted by the inclusion server;
establishing a second communication session between the inclusion server and the content server;
transmitting the first search request from the inclusion server to the content server as if the first search request came directly from the client system;
receiving, by the inclusion server, data from the content server defining a results Web page containing content satisfying the first search request, the content instantiating a content search variable; and
storing the content search variable in the search agent on the inclusion agent server.

4. The method of claim 3, further comprising the step of defining a Web page for evoking the search agent to send a second search request from the client system to the content server, the Web page including a form field to receive a value supplied by the client system to instantiate the content search variable.

5. A method for automating a search of a Web site comprising the steps of:
(a) receiving a start URL for a Web site to be searched;
(b) sending a request to a server hosting the Web site;
(c) receiving, from the server, data defining a Web page in response to the request;
(d) determining a search heuristic defined by the data; and
(e) emitting code to access the Web page according to the search heuristic.

6. The method of claim 5, wherein the step of emitting code includes parameterizing a search variable in the search heuristic for instantiation with a value specified for a subsequent search.

7. The method of claim 6, further comprising the step of analyzing the data defining the Web page to determine if the Web page contains a result satisfying the request.

8. The method of claim 7, wherein the analyzing step includes searching the data for a value representing the parameterized variable.

9. The method of claim 7, wherein the analyzing step includes searching the data for the absence of a markup language form tag.

10. The method of claim 7, wherein the analyzing step includes receiving interactive identification of the result from a client system user.

11. The method of claim 7, further comprising the step of, responsive to obtaining a plurality of results satisfying the request, aggregating the plurality of results into an aggregate result.

12. The method of claim 11, wherein the aggregate result includes a result URL.

13. The method of claim 5, wherein the start URL is provided by a client system user.

14. The method of claim 5, wherein the start URL is imported from an external source.

15. The method of claim 5, wherein the start URL is generated by a commercial Internet search engine in response to a key word search.

16. The method of claim 5, further comprising the steps of, prior to the step of receiving the start URL:
conducting an Internet search for a search-result Web page containing a predefined key word, the search-result Web page being identifiable by a reference URL; and
providing the reference URL identifying the search-result Web page as the start URL in the subsequent step of receiving the start URL.

17. The method of claim 16 wherein the search is a meta tag search.

18. A system for generating code to enable a client system to search for content on at least one of a plurality of content servers, the system comprising:
a client system coupled to a network;
a content server coupled to the network, the content server providing searchable content available to the client system according to a predefined search methodology; and
an inclusion server, coupled to the network, for intercepting communications between the client system and the content server, deducing the predefined search methodology, and emitting code for automating a search of the searchable content according to the deduced, predefined search methodology.

19. A system of claim 18 further comprising an inclusion agent, hosted by the inclusion server, for emitting the code.

20. A system for enabling an automatic search of one or more Web sites and aggregating one or more search results comprising:
an initial Web page for receiving information identifying the one or more Web sites to be learned;
an inclusion script for receiving information from the Web sites to be learned and determining a corresponding search methodology for each of the Web sites to be learned; and
a code script for implementing the search methodology determined by the inclusion script for each of the Web sites to be learned.

21. The system of claim 20, further comprising:
a search Web page for receiving a single search request; and
a results script for obtaining one ore more search results, parsing the one or more search results, and aggregating the one or more search results into an aggregate output.

22. The system of claim 21 wherein the aggregate output is chosen from a group consisting of a results Web page, a data table; an e-mail communication, a computer file, a computer database, and a printout.

23. The system of claim 20 wherein the inclusion script includes the following:
a first routine to request, from each of the one or more Web sites, a first Web page for inputting a search parameter; and
a second routine to request, from each of the one or more Web sites, a subsequent Web page in response to inputting the search parameter, the second routine including an iteration subroutine to repeat the subsequent Web page request until the subsequent Web page presents a final result.

24. A system for enabling a computer user having minimal computer experience to distributively generate a customized search agent, the system comprising:
a client system coupled to a network, the client having a network browser;
a set of graphical interfaces, operable with the network browser, including:
an interactive start Web page for receiving from the computer user an identification of one or more Web sites to be searched;
an interactive search Web page for receiving from the computer user an identification of a requested content available on the one or more Web sites; and
an interactive results Web page for providing the computer user with the requested content in an aggregated form; and
an inclusion agent server for hosting code-generating scripts to generate the customized search agent, the code-generating scripts being substantially hidden from the computer user and including:
an inclusion script to identify and record a search methodology for the one or more Web sites;
a code script containing the identified and recorded search methodology; and
a results script for aggregating the requested content and providing the requested content to the interactive results Web page.

25. The system of claim 24 wherein the interactive results Web page provides the requested content in a table.

26. The system of claim 25 wherein the computer user can specify an order for data in the table.

27. The system of claim 24 wherein the interactive search Web page includes an option for the computer user to select which of the one or more Web sites to search.

28. A method for facilitating a B2B exchange among a first entity and a second entity having an online presence, the method comprising the steps of:
providing a server to monitor a methodology used by the first entity to search for content through the online presence of the second entity; and
enabling the first entity to use a Web browser to generate a search agent for searching for content according to the monitored methodology.

29. A method for enabling a novice computer user to generate an agent to automate an action conducted by the computer user on a network, the method comprising the steps of:
providing a gateway presence on the network, the gateway presence being accessible to the computer user with a network browser application;
receiving through the gateway presence a communication from the user exemplifying the action; and
providing a preprogrammed computer program to monitor the communication and automatically generate the agent for automating the action.
